(19) United States
(12) Patent Application Publication
(10) Pub. No.: US 2012/0070244 A1
(43) Pub. Date: Mar. 22, 2012

(54) Nibbling Mechanism for Construction Material

(75) Inventor: Izhak Stern, Rehovot (IL)

(73) Assignee: Izhak Stern Y.D.E. Engineers Ltd., Tel Aviv (IL)

(21) Appl. No.: 13/202,541

(22) PCT Filed: Feb. 21, 2010
(86) PCT No.: PCT/IL2010/000146

§ 371 Date: Nov. 29, 2011

Related U.S. Application Data
(60) Provisional application No. 61/153,875, filed on Feb. 19, 2009.
(60) Provisional application No. 61/253,873, filed on Oct. 22, 2009.

(51) Int. Cl. B23B 51/00; B28D 1/14

(52) U.S. Cl. 408/1 R; 408/147; 408/56

(57) ABSTRACT

Nibbling mechanism (100) for producing a plurality of indented surfaces within a cavity within a construction material (160) including a tube, a plurality of cutters and a cutter moving mechanism, each of the cutters (104) being coupled with the tube (120), the tube (120) being rotatable by a power shaft rotator, the tube including a tube longitudinal axis, the plurality of cutters (104) producing the plurality of indented surfaces within the cavity, the cutter moving mechanism forcing the plurality of cutters (104) in a radial direction away from the tube longitudinal axis toward the cavity, thereby producing the plurality of indented surfaces, wherein the cutter moving mechanism can be inserted into the tube (120).

### FIELD OF THE DISCLOSED TECHNIQUE

The disclosed technique relates to nibbling mechanisms in general, and to methods and systems for producing indented surfaces in a cavity in a construction material for anchoring an anchor in the construction material, in particular.

### BACKGROUND OF THE DISCLOSED TECHNIQUE

Load carrying members are connected to construction materials, such as concrete, usually by means of an anchor. Methods and systems for anchoring the anchor in construction materials are known in the art. A first type of such an anchor is the expandable one. The expandable anchor includes an expandable element at a trailing end thereof, which can be expanded by turning a bolt located at a leading end of the anchor, once the anchor is inserted into a bore in the construction material. The expandable element expands against an inner wall of the bore, thereby applying a radial force to the inner wall and preventing the anchor from being dislodged from the construction material under a tensile load. Another type of anchor is in the form of a rod (e.g., an externally threaded stud or a rebar) having a rough surface. The rod is inserted in a bore of the construction material, whose diameter is slightly larger than the outer diameter of the rod. The space between the rod and the inner wall of the bore is then filled with an adhesive. In this manner, the rod is fastened to the construction material as the proof load of the anchor whose outer surface is rough and is larger than one whose outer surface is smooth.

U.S. Pat. No. 4,712,957 issued to Edwards et al., and entitled “Adhesively Secured Fastener,” is directed to a cylindrical fastener for joining two pieces of material. The cylindrical fastener includes a plurality of external longitudinal channels, a plurality of apertures and an axial cavity. The apertures communicate with the external longitudinal channels through the axial cavity. The apertures are located at a leading edge of the cylindrical fastener. To connect a first panel to a second panel, a through bore is drilled in the first panel, and a bore is drilled in the second panel. The cylindrical fastener is inserted into the through bore of the first panel, and then into the bore of the second panel. A fluent glue-type adhesive is forced into the axial cavity through the apertures, thus filling the space adjacent to the cylindrical fastener and the first and second panels.

U.S. Pat. No. 4,063,582 issued to Fischer and entitled “Arrangement for and a Method of Anchoring a Mounting Element in a Hole of Masonry and the Like,” is directed to a method for mounting a threaded element in masonry by means of a mounting element. The mounting element includes a central bore, a plurality of projections, a transverse bore, a plurality of ribs and a plurality of transverse ribs. The central bore extends from a leading end portion of the mounting element to a trailing end portion thereof in an axial direction. The projections are located in an inner surface of the mounting element, extending in an axial direction, and facilitating screwing of the threaded element into the central bore.

The central bore communicates with a circumferential recess between the outer surface of the mounting element and a hole in the masonry by means of the transverse bore. The ribs are located at the trailing end portion of the mounting element and serve for holding the mounting element in a predetermined position relative to the hole. The transverse ribs prevent axial displacement of the mounting element relative to the hole after anchoring the mounting element by a hardened binding material.

In order to anchor the mounting element to the masonry, the mounting element is inserted into the hole. An adaptor element is inserted into the central bore, and a hardenable binding material is injected into the central hole, through the adaptor element. The hardenable binding material travels through the transverse bore and fills the circumferential recess between the transverse bore and the hole in the masonry. The hardenable binding material hardens in the circumferential recess, thereby anchoring the mounting element to the masonry.

U.S. Pat. No. 6,393,795 B1 issued to Irwin et al., and entitled “Adhesive Anchor and System,” is directed to a method for fastening a threaded shaft member in a work material, such as concrete or masonry, by means of an adhesive anchor system. The adhesive anchor system includes an anchor member and a tube member. The anchor member includes a partially threaded opening in an inner surface thereof, a plurality of annular rib members on an outer portion thereof and a cap member which covers the partially threaded opening. The anchor member includes a counterbore at the partially threaded opening. A first end of the tube member is disposed and retained in the counterbore by an adhesive. The adhesive anchor system is inserted in a bore of the work material. An axial portion of the tube member protrudes from the work material. The tube member and the cap prevent debris and the adhesive from contaminating the partially threaded opening. After the bonding is complete, the protruding portion of the tube member is removed and a threaded portion of the threaded shaft is engaged with the partially threaded opening of the anchor member.

### SUMMARY OF THE PRESENT DISCLOSED TECHNIQUE

It is an object of the disclosed technique to provide a novel method and system for producing indented surfaces in a cavity in a construction material for anchoring an anchor in the cavity which overcomes the disadvantages of the prior art. In accordance with the disclosed technique, there is thus provided a nibbling mechanism for producing a plurality of indented surfaces within a cavity within a construction material. The nibbling mechanism includes a rod, a plurality of cutters and a cutter moving mechanism. The rod is rotatable by a power shaft rotator and includes a rod longitudinal axis. Each of the cutters is coupled with the rod and with the cutter moving mechanism. The plurality of cutters is for producing the plurality of indented surfaces within the cavity. The cutter moving mechanism is for forcing the plurality of cutters in a radial direction away from the rod longitudinal axis toward the cavity, thereby producing the plurality of indented surfaces.

According to another aspect of the disclosed technique, there is thus provided a nibbling mechanism for producing a plurality of indented surfaces within a cavity within a construction material. The nibbling mechanism includes a tube, a plurality of cutters and a cutter moving mechanism. The tube is rotatable by a power shaft rotator and includes a tube longitudinal axis. Each of the cutters is coupled with the tube and the cutter moving mechanism. The plurality of cutters is for producing the plurality of indented surfaces within the cavity. The cutter moving mechanism is for forcing the plurality of cutters in a radial direction away from the tube longitudinal axis toward the cavity, thereby producing the plurality of indented surfaces. The cutter moving mechanism can be inserted into the tube.

According to a further aspect of the disclosed technique, there is thus provided a nibbling mechanism for producing a plurality of indented surfaces within a cavity within a construction material. The nibbling mechanism includes a tube, a plurality of cutters and a cutter moving mechanism. The tube is rotatable by a power shaft rotator and includes a tube longitudinal axis. Each of the cutters is coupled with the tube. The plurality of cutters is for producing the plurality of indented surfaces within the cavity. The cutter moving mechanism is for forcing the plurality of cutters in a radial direction away from the tube longitudinal axis toward the cavity, thereby producing the plurality of indented surfaces. The cutter moving mechanism can be inserted into the tube.

According to another aspect of the disclosed technique, there is thus provided a method for producing a plurality of indented surfaces in a cavity in a construction material, for anchoring an anchor in the cavity. The method includes the procedures of inserting a nibbling mechanism in the cavity in the construction material, the cavity and the nibbling mechanism each having a cylindrical body and the nibbling mechanism including a plurality of cutters. A plurality of indented surfaces is produced within the cavity, by forcing the plurality of cutters in a radial direction away from a longitudinal axis of the nibbling mechanism, while rotating the nibbling mechanism. The plurality of cutters is retracted away from the indented surfaces, back toward the longitudinal axis, and the nibbling mechanism is removed from the cavity. The method can include a preliminary procedure of drilling the cavity. The method can also include the procedures of inserting the anchor in the cavity, after the plurality of indented surfaces has been produced in the cavity, and coupling the anchor with the cavity with a settable material.

### BRIEF DESCRIPTION OF THE DRAWINGS

The disclosed technique will be understood and appreciated more fully from the following detailed description taken in conjunction with the drawings in which:

FIG. 1A is a schematic illustration of a nibbling mechanism constructed and operative according to an embodiment of the disclosed technique;

FIG. 1B is a schematic illustration of a cross section (cross section I) of the nibbling mechanism of FIG. 1A;

FIG. 1C is a schematic illustration of a side view (view II) of the nibbling mechanism of FIG. 1A;

FIG. 2A is a schematic illustration of a construction material having a cylindrical hole;

FIG. 2B is a schematic illustration of the nibbling mechanism of FIG. 1A, located within the cylindrical hole of FIG. 2A, the nibbling mechanism being in a pre-nibbling mode;

FIG. 2C is a schematic illustration of the nibbling mechanism of FIG. 2B, in a nibbling mode;

FIG. 2D is a schematic illustration of a plurality of depressions within the construction material of FIG. 2A, produced by the nibbling mechanism of FIG. 2C;

FIG. 3A is a schematic illustration of a nibbling mechanism in a pre-nibbling mode, constructed and operative according to another embodiment of the disclosed technique;

FIG. 3B is a schematic illustration of a cross section (cross section III) of the nibbling mechanism of FIG. 3A;

FIG. 3C is a schematic illustration of the nibbling mechanism of FIG. 3A, in a nibbling mode;

FIG. 4A is a schematic illustration of a nibbling mechanism in a pre-nibbling mode, constructed and operative according to a further embodiment of the disclosed technique;

FIG. 4B is a schematic illustration of a cross section (cross section IV) of the nibbling mechanism of FIG. 4A;

FIG. 4C is a schematic illustration of the nibbling mechanism of FIG. 4A, in a nibbling mode;

FIG. 5A is a schematic illustration of a nibbling mechanism in a pre-nibbling mode, constructed and operative according to another embodiment of the disclosed technique;

FIG. 5B is a schematic illustration of a cross section (cross section V) of the nibbling mechanism of FIG. 5A;

FIG. 5C is a schematic illustration of the nibbling mechanism of FIG. 5A, in a nibbling mode;

FIG. 6A is a schematic illustration of a nibbling mechanism in a pre-nibbling mode, constructed and operative according to a further embodiment of the disclosed technique;

FIG. 6B is a schematic illustration of the nibbling mechanism of FIG. 6A, in a nibbling mode;

FIG. 7A is a schematic illustration of a nibbling mechanism in a pre-nibbling mode, constructed and operative according to another embodiment of the disclosed technique;

FIG. 7B is a schematic illustration of a cross section (cross section VI) of the nibbling mechanism of FIG. 7A;

FIG. 7C is a schematic illustration of the nibbling mechanism of FIG. 7A, in a nibbling mode;

FIG. 7D is a schematic illustration of a cross section (cross section VI) of a nibbling mechanism, similar to the nibbling mechanism of FIG. 7A, constructed and operative according to a further embodiment of the disclosed technique;

FIG. 8 which is a schematic illustration of a method for producing depressions in a cavity within a construction material for fixing an anchor in the cavity, operative according to another embodiment of the disclosed technique;

FIG. 9A is a schematic illustration of a nibbling mechanism in a pre-nibbling mode, shown in an exploded view, constructed and operative according to a further embodiment of the disclosed technique;

FIG. 9B is a schematic illustration of two cross sections (cross sections VII and VIII) of the nibbling mechanism of FIG. 9A, shown in an assembled perspective view;

FIG. 9C is a schematic illustration of a cross section (cross section VII) of the nibbling mechanism of FIG. 9A, in a nibbling mode;

FIG. 9D is a schematic illustration of a cross section (cross section IX) of the nibbling mechanism of FIG. 9A, in a pre-nibbling mode;

FIG. 9E is a schematic illustration of the cross section of FIG. 9D in a perspective view; and

FIGS. 9F_{/1} and 9F_{/2} are schematic illustrations of the nibbling mechanism of FIG. 9A, including a cutter moving mechanism, shown in various perspective and orthogonal views.

### DETAILED DESCRIPTION OF THE EMBODIMENTS

The disclosed technique overcomes the disadvantages of the prior art by providing a nibbling mechanism which includes a shaft, a plurality of cutters and a cutter moving mechanism. The cutters are coupled with the shaft and with the cutter moving mechanism. A user inserts the nibbling mechanism into a cylindrical pre-drilled hole of a construction material, such as concrete, masonry, rock, pile, stone, marble, granite and the like, and rotates the shaft with a power drill. Either by pushing the shaft against a bottom surface of the cylindrical pre-drilled hole, or due to rotation of the shaft by the power drill, the cutter moving mechanism moves the cutters away from a longitudinal axis of the shaft, allowing each of the cutters to carve a depression within an inner wall of the pre-drilled hole. The depressions can also be referred to as indentations, indented surfaces or protrusions in the cylindrical pre-drilled hole, extending into the surface of the cylindrical pre-drilled hole. Either by relieving the pressure from the shaft, or by rotating the shaft in reverse, the cutter moving mechanism moves the cutters back toward the longitudinal axis, thereby clearing the way for the user to withdraw the nibbling mechanism. It is noted that throughout the description, the terms “cylindrical hole,” “cavity” and “pre-dilled hole” are used interchangeably to refer to a hole or cavity produced in a construction material, for example by drilling, into which the nibbling mechanism of the disclosed technique is inserted into to form depressions or indented surfaces within the cavity.

After withdrawal of the nibbling mechanism from the cylindrical pre-drilled hole, the user anchors an anchor (e.g., rebar, bolt, stud, threaded stud) to the construction material, by inserting the anchor into the cylindrical pre-drilled hole, which now includes a plurality of depressions or indented surfaces, and filling the space between the anchor and the inner wall, with a settable material, such as epoxy, an unsaturated polyester made of diols and dicarbolic acids, styrene free vinylester, hybrid systems, adhesives, any type of known grout (such as epoxy grout, cement-based grout and furan resin grout) and the like. The cylindrical hole with the indented surfaces substantially forms a mechanical interlock for increasing the pull-out resistance of the anchor. The anchor which is dovetailed with the construction material, through the settable material having a plurality of cylindrical indented surfaces within the inner wall, has a greater pull-out resistance than an anchor which is engaged with the construction material in a plain drilled hole (i.e., devoid of any depressions or indented surfaces). It is noted that the disclosed technique can be used when anchoring a newly cast piece of construction material with a previously cast (i.e., old) piece of construction material. For example, a piece of newly cast concrete anchored with a piece of previously cast concrete can be anchored using a rebar. Using the disclosed technique, the respective cavities in the newly cast concrete and the previously cast concrete, into which the rebar is inserted, can be formed to have depressions, as described below, thereby forming a mechanical interlock between the cavities and increasing the pull-out resistance of the anchor.

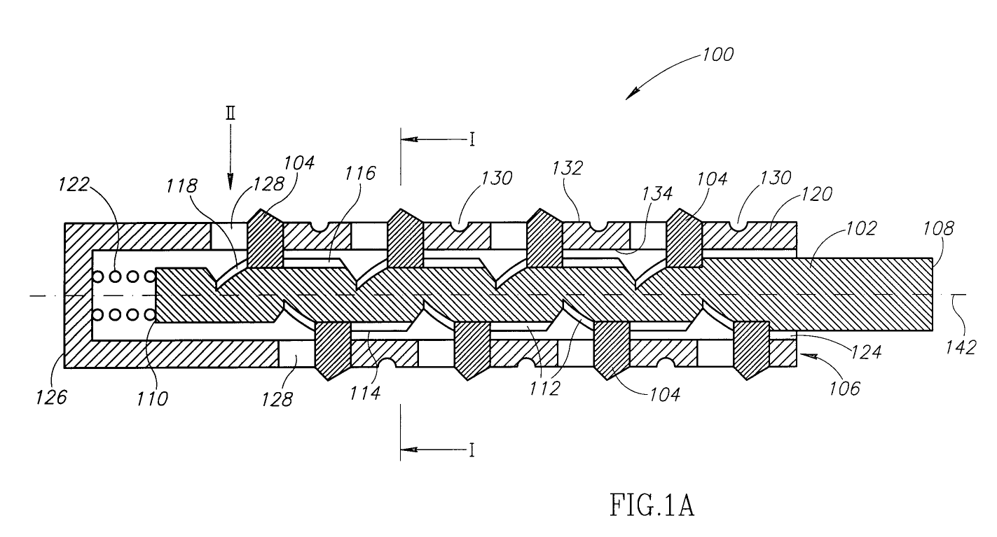

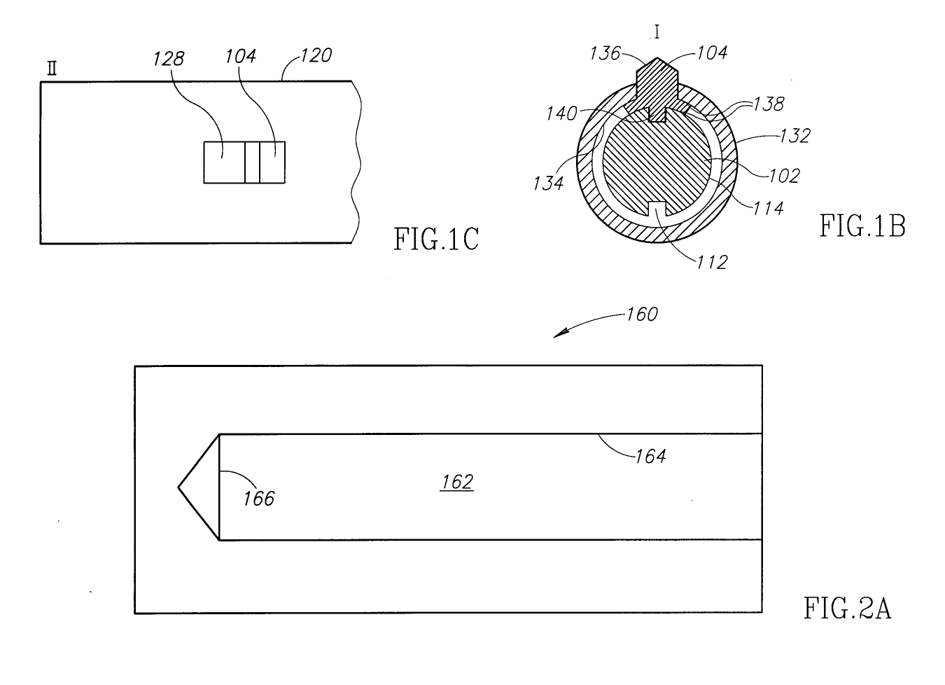

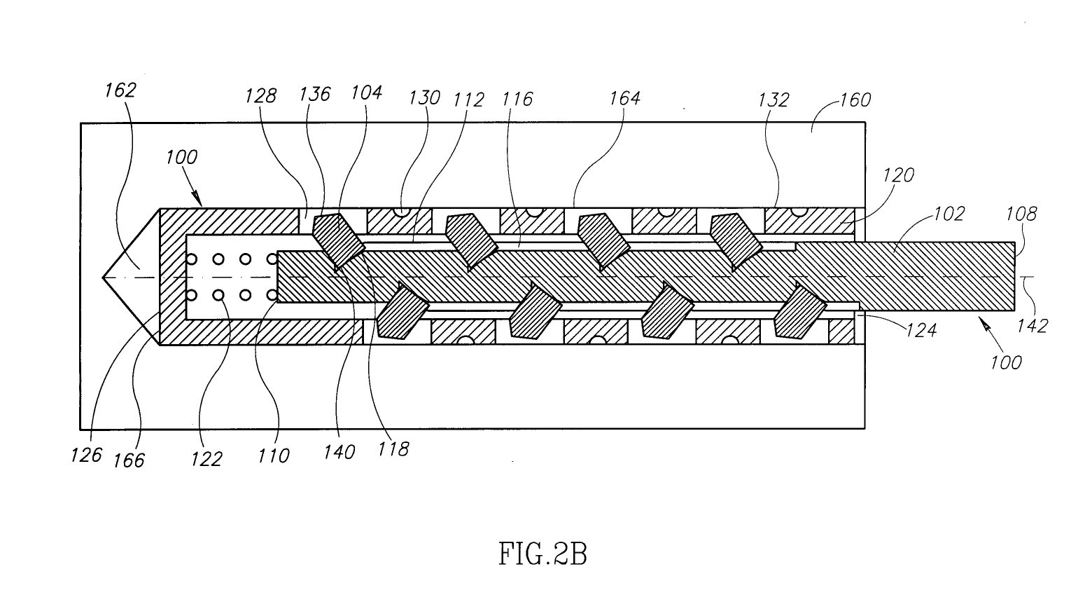

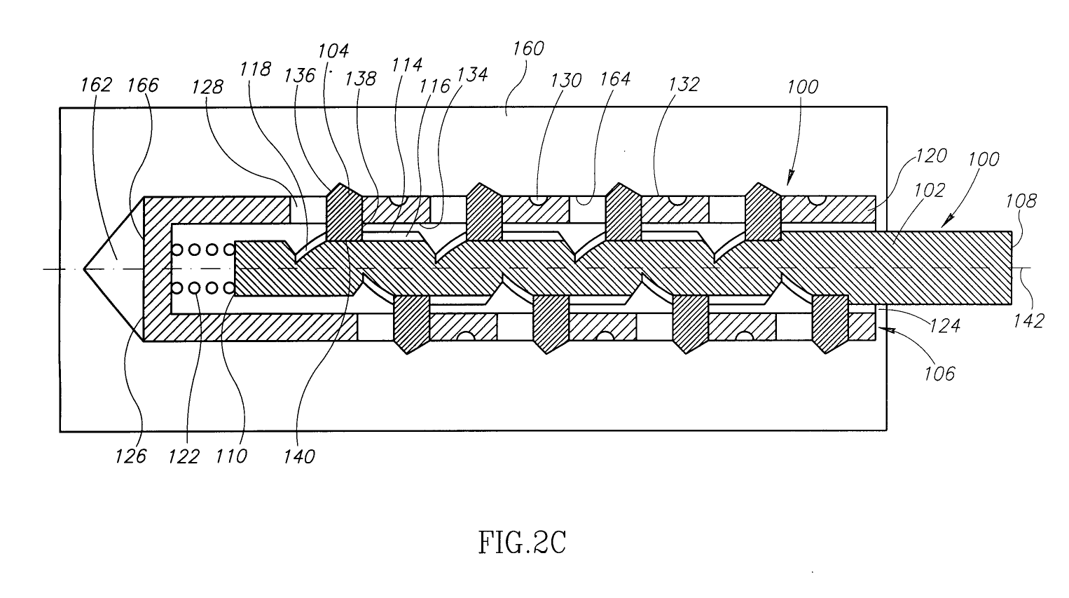

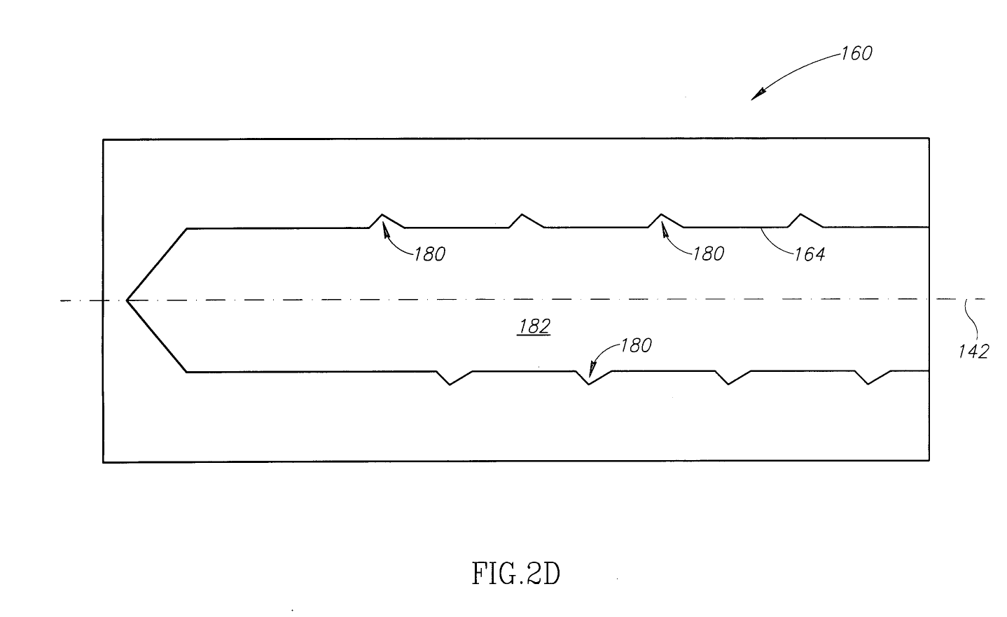

Reference is now made to FIGS. 1A, 1B, 1C, 2A, 2B, 2C, and 2D. FIG. 1A is a schematic illustration of a nibbling mechanism generally referenced 100, constructed and operative according to an embodiment of the disclosed technique. FIG. 1B is a schematic illustration of a cross section (cross section I) of the nibbling mechanism of FIG. 1A. FIG. 1C is a schematic illustration of a side view (view II) of the nibbling mechanism of FIG. 1A. FIG. 2A is a schematic illustration of a construction material generally referenced 160, having a cylindrical hole. FIG. 2B is a schematic illustration of the nibbling mechanism of FIG. 1A, located within the cylindrical hole of FIG. 2A, the nibbling mechanism being in a pre-nibbling mode. FIG. 2C is a schematic illustration of the nibbling mechanism of FIG. 2B, in a nibbling mode. FIG. 2D is a schematic illustration of a plurality of depressions or indented surfaces within the construction material of FIG. 2A, produced by the nibbling mechanism of FIG. 2C.

With reference to FIGS. 1A, 1B and 1C, nibbling mechanism 100 includes a rod 102 (i.e., cylindrical shaft), a plurality of cutters 104 and a moving mechanism 106. Rod 102 includes a rear end 108, a front end 110, a plurality of grooves 112 and an outer surface 114. Each of grooves 112 includes a substantially straight portion 116 and a curved portion 118. Moving mechanism 106 includes a tube 120 and a spring 122. Tube 120 includes an opening 124, a cap 126, a plurality of slots 128, a helical groove 130, an outer surface 132 and an inner surface 134. Each of cutters 104 includes a cutting edge 136, a support surface 138 and a guide 140.

With reference to FIG. 2A, a user (not shown) makes a cylindrical hole 162 in construction material 160, with the aid of a power shaft rotator (not shown), such as a power drill, a power drill-hammer combination, a power screwdriver and the like, as known in the art. An inner wall of cylindrical hole 162 is referenced 164. A bottom surface of cylindrical hole 162 is referenced 166. An inner diameter (not shown) of cylindrical hole 162 is substantially equal or greater than an outer diameter (not shown) of tube 120 (FIG. 1A). A depth (not shown) of cylindrical hole 162 is substantially equal to or greater than a length (not shown) of tube 120. Construction material 160 is a material used for constructing a static structure (e.g., a building or bridge), such as concrete, masonry, rock, pile, stone, marble, granite and the like.

According to the disclosed technique, the user employs nibbling mechanism 100 to form a plurality of depressions or indented surfaces in inner wall 164, as described herein below, to anchor an anchor (not shown) to construction material 160 with the aid of a settable material (i.e., a resin—not shown), such as epoxies, unsaturated polyester made of diols and dicarbolic acids, styrene free vinylester, hybrid systems, adhesives, any type of known grout (such as epoxy grout, cement-based grout and furan resin grout) and the like. The settable material, after it is set within the space between inner wall 164 and the anchor, dovetails into construction material 160, thereby providing the anchor an increased pull-out resistance. The anchor is made of a rod having an external thread on a protruding portion thereof, which protrudes from cylindrical hole 162, in order to enable attachment of an object (not shown), such as a bracket and the like, to construction material 160. Alternatively, the protruding portion can be in the form of a hook (not shown), to enable for example, attachment of a turnbuckle (not shown), bolt insert (not shown) and the like.

With reference to FIG. 2B, rod 102 is located within tube 120. Spring 122 is located between front end 110 and cap 126. Spring 122 is a compression spring which tends to force rod 102 out from opening 124. Each of cutting edges 136 is made of a material suitable for carving through construction material 160, as known in the art. A cross section (not shown) of cutting edge 136 can be for example, in the shape of a sawtooth, rectangle, triangle and the like. In the pre-nibbling mode illustrated in FIG. 2B, guide 140 of respective ones of cutters 104 is located within a respective curved portion 118, such that respective cutting edges 136 are located within respective slots 128, and cutters 104 are concealed within tube 120. It is noted that throughout the description, the terms “pre-nibbling mode” and “nibbling mode” are used to describe the location of the cutting edges or cutters relative to the nibbling mechanism. In a pre-nibbling mode, the cutting edges or cutters substantially align or are retracted within the nibbling mechanism such that the nibbling mechanism can be inserted into and retracted from the cavity. In a nibbling mode, the cutting edges or cutters protrude from the nibbling mechanism such that they form indented surfaces, or depressions, in the cavity in the construction material. Following is a description of a method to assemble nibbling mechanism 100.

For example, the user can insert spring 122 into tube 120, against cap 126. The user inserts each of cutters 104 (FIG. 1A) into tube 120, and into respective ones of slots 128, and keeps cutters 104 in this position, for example, by a plurality of magnets (not shown), a removable adhesive and the like. The user inserts rod 102 into tube 120, such that guides 140 of respective cutters 104 pass through substantially straight portions 116, one by one, until front end 110 rests on spring 122. The user pushes rear end 108, thereby forcing each of cutters 104 against respective one of slots 128, such that respective ones of guides 140 slides on curved portion 118, and each of cutters 104 moves to the position illustrated in FIG. 2B, concealed within tube 120. In this pre-nibbling mode, the user inserts nibbling mechanism 100 into cylindrical hole 162, until cap 126 reaches bottom surface 166.

Following is a description of a procedure for preparing cylindrical hole 162 with a plurality of depressions or indented surfaces for anchoring the anchor to construction material 160. With reference to FIGS. 2C and 2D, the user inserts rear end 108 into a chuck (not shown) of a power drill (not shown). As the power drill rotates nibbling mechanism 100, the user pushes rod 102 against spring 122. This push forces each of cutters 104 against respective slots 128, causing guides 140 of respective cutters 104 to slide on respective curved portions 118, toward rear end 108 and away from a rod longitudinal axis 142 of rod 102. This sliding motion takes place while nibbling mechanism 100 is rotating, thereby allowing each of cutting edges 136 to protrude from outer surface 132, move away from rod longitudinal axis 142, and carve a respective depression, or indented surface, 180 (FIG. 2D) into cylindrical inner wall 164. Through the contact of guides 140 with the respective ones of substantially straight portions 116, the rotation of rod 102 rotates cutters 104 together with tube 120, to allow cutting edges 136 to carve depressions 180. Each of depressions 180 is substantially annular and extends around the circumference of cylindrical inner wall 164 (not shown in FIG. 2D).

By being confined between inner surface 134 and outer surface 114, support surfaces 138 provide support for respective ones of cutters 104, while cutters 104 carve depressions 180. Helical groove 130 is located on outer surface 132 and is in the form of flutes (not shown), as in a drill bit (not shown) as known in the art. Helical groove 130 carries the dust which is produced by carving depressions 180 through construction material 160, and which accumulates on outer surface 132, out of cylindrical hole 162. It is also noted that compressed air can be used while using nibbling mechanism 100 to force dust and debris out of cylindrical hole 162 (FIG. 2A). Compressed air can be provided to nibbling mechanism 100 via an air compressor (not shown) or a canister of compressed air (not shown). Compressed air can be introduced into nibbling mechanism 100 while nibbling mechanism 100 is in use by providing the compressed air to the space between inner surface 134 and outer surface 114 (as shown in FIG. 1B). In another embodiment of the disclosed technique, rod 102 can be produced as a hollow rod (not shown) such that compressed air can be introduced into nibbling mechanism 100 via a rear end (not shown) of the hollow of the rod and released via a front end (not shown) of the hollow of the rod. In a further embodiment of the disclosed technique, rod 102 can be produced as a hollow rod (not shown) having lengthwise holes along the wall of the hollow rod (not shown) such that compressed air can be introduced into nibbling mechanism 100 via a rear end (not shown) of the hollow of the rod and released via the lengthwise holes (not shown) of the rod. In this manner, a cavity 182 (FIG. 2D) is produced in construction material 160, which includes depressions 180, thereby enabling the user to anchor the anchor to construction material 160. A depression radius (not shown) of each of depressions 180, from a cavity longitudinal axis 184 (FIG. 2D) of cavity 182, is greater than an inner wall radius (not shown) of cylindrical inner wall 164, measured from cavity longitudinal axis 184.

In order to withdraw nibbling mechanism 100 from cavity 182, the user relieves the pushing force on rod 102 (FIG. 2B). Releasing the force on rod 102 allows spring 122 to force rod 102 out from opening 124. Each of cutters 104 makes contact with respective slots 128 and guides 140 slide in respective curved portions 118, toward front end 110. As this occurs, cutters 104 move toward rod longitudinal axis 142 and clear the way for nibbling mechanism 100 to move out of cavity 182.

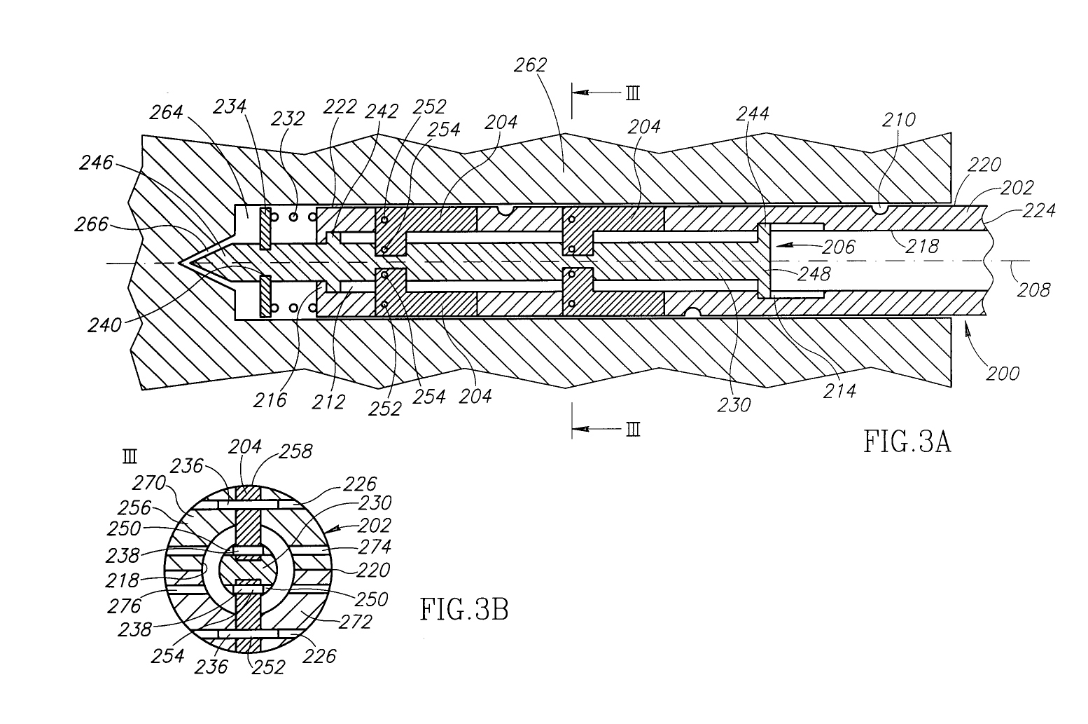

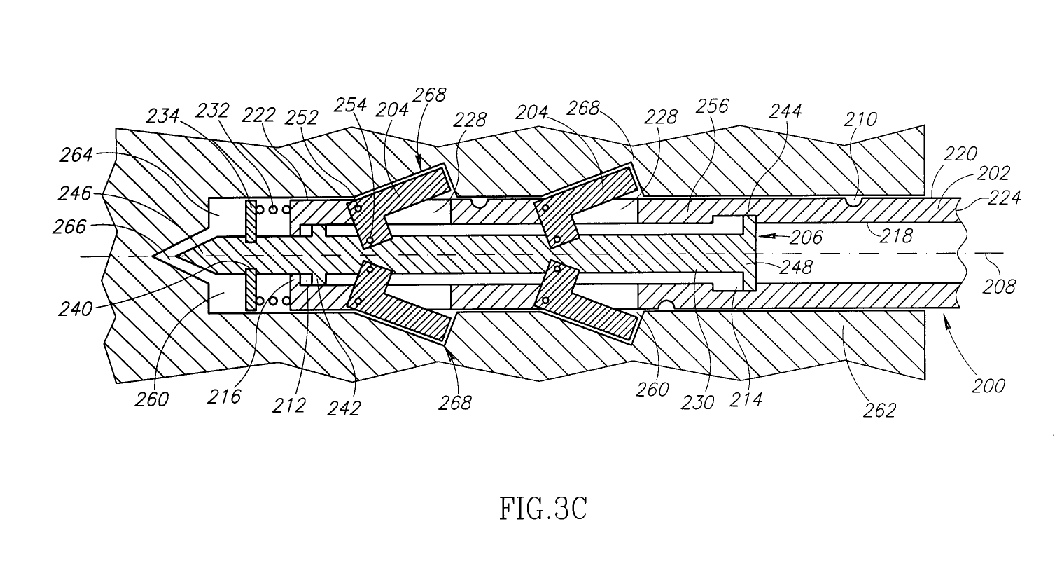

Reference is now made to FIGS. 3A, 3B and 3C. FIG. 3A is a schematic illustration of a nibbling mechanism generally referenced 200, in a pre-nibbling mode, constructed and operative according to another embodiment of the disclosed technique. FIG. 3B is a schematic illustration of a cross section (cross section III) of the nibbling mechanism of FIG. 3A. FIG. 3C is a schematic illustration of the nibbling mechanism of FIG. 3A, in a nibbling mode.

Nibbling mechanism 200 includes a tube 202, a plurality of cutters 204, a cutter moving mechanism 206 and a longitudinal axis 208. Tube 202 (i.e., shaft) includes a helical groove 210, a front linear bearing 212, a rear linear bearing 214, a cap 216, an inner surface 218, an outer surface 220, a front end 222, a rear end 224, a plurality of tube pin bores 226 (FIG. 3B) and a plurality of openings 228 (FIG. 3C). Cutter moving mechanism 206 includes a piston 230, a spring 232, a retaining ring 234, a plurality of tube pins 236 (FIG. 3B) and a plurality of piston pins 238 (FIG. 3B). Piston 230 includes a retaining ring groove 240, a front journal 242, a rear journal 244, a front end 246, a rear end 248, a plurality of piston pin bores 250 (FIG. 3B) and a plurality of piston depressions (not shown). Each of cutters 204 includes a tube pinhole 252 and a piston pinhole 254.

Helical groove 210 is located on outer surface 220. Front linear bearing 212 and rear linear bearing 214 are located within inner surface 218. Piston 230 is located within tube 202. Piston 230 and tube 202 share the same longitudinal axis 208. Front journal 242 can slide within front linear bearing 212 along longitudinal axis 208. Rear journal 244 can slide within rear linear bearing 214 along longitudinal axis 208. Retaining ring groove 240 is located at front end 246. Retaining ring 234 is located on retaining ring groove 240. Spring 232 is located between retaining ring 234 and cap 216. Spring 232 is a compression spring which forces piston 230 toward front end 222. Openings 228 are located in a wall 256 (FIG. 3B) of tube 202. Tube pin bores 226 are located in wall 256. Piston pin bores 250 are located in piston 230. A tube pin bore longitudinal axis (not shown) of each of tube pin bores 226 is substantially parallel with a piston pin bore longitudinal axis (not shown) of each of piston pin bores 250. Tube pins 236 are located within tube pin bores 226 and tube pinholes 252. Piston pins 238 are located within piston pin bores 250 and piston pinholes 254.

Each pair of tube pins 236 and tube pin bores 226 forms a first hinge (not shown), about which the respective ones of cutters 204 can rotate. Each pair of piston pins 238 and piston pin bores 250 forms a second hinge (not shown), about which the respective ones of cutters 204 can rotate. Based on rotations of cutters 204 about the first hinge and the second hinge, a linear movement of piston 230 toward front end 222, forces cutters 204 to move toward longitudinal axis 208, while a linear movement of piston 230 toward rear end 224, forces cutters 204 to move away from longitudinal axis 208. Front linear bearing 212 and rear linear bearing 214 restrict the movement of piston 230 between an extreme front position, as illustrated in FIG. 3A, and an extreme rear position, as illustrated in FIG. 3C. When piston 230 is located at the extreme front position, an outer surface 258 of each of cutters 204 is substantially aligned with outer surface 220 (FIG. 3B). When piston 230 is located at the extreme rear position, each of cutters 204 protrudes from the respective one of openings 228 (FIG. 3C).

Following is a description of a method for preparing a cavity 260 (FIG. 3C) with a plurality of depressions within a construction material 262. The user drills a cylindrical hole 264 in construction material 262, with the aid of a power drill (not shown) as known in the art. Cylindrical hole 264 includes a bottom 266. With reference to FIG. 3A, the user inserts rear end 224 in a chuck (not shown) of a power drill (not shown), and inserts nibbling mechanism 200 into cylindrical hole 264. While the power drill rotates nibbling mechanism 200, the user forces nibbling mechanism 200 toward bottom 266. Front end 246 makes contact with bottom 266, and the push by the user forces piston 230 toward rear end 224, against the spring force of spring 232. As nibbling mechanism 200 rotates, each of cutters 204 moves away from longitudinal axis 208 and out through respective ones of openings 228, allowing each of cutters 204 to carve a depression 268 within construction material 262. As mentioned above, compressed air can be used while using nibbling mechanism 200 to force dust and debris out of cylindrical hole 264 (FIG. 3A). Compressed air can be introduced into nibbling mechanism 200 while nibbling mechanism 200 is in use by providing the compressed air to the space between piston 230 and tube 202 (as shown in FIGS. 3A and 3B). In addition, as mentioned above, piston 230 can be produced as a hollow piston (not shown) and may include lengthwise holes along the wall of the hollow piston. The user then stops the rotation of the power drill. When the user releases the push on nibbling mechanism 200, spring 232 forces piston 230 to move to the extreme front position (FIG. 3A), and each of cutters 204 moves back toward longitudinal axis 208 and into respective ones of openings 228. Outer surface 258 (FIG. 3B) of the respective ones of cutters 204 is now substantially aligned with outer surface 220, and the user can withdraw nibbling mechanism 200 from cavity 260.

Nibbling mechanism 200 can be manufactured for example as follows. Tube 202 can include a first longitudinal half 270 (FIG. 3B), and a second longitudinal half 272 (FIG. 3B). First longitudinal half 270 includes a first set of pinholes 274, substantially aligned with a respective ones of piston pin bores 250, as well as tube pin bores 226. Second longitudinal half 272 includes a second set of pinholes 276, substantially aligned with a respective ones of piston pin bores 250, as well as tube pin bores 226. The user inserts each of cutters 204 into respective ones of openings 228 in first longitudinal half 270 and in second longitudinal half 272, and passes respective ones of tube pins 236, through respective ones of tube pin bores 226, into respective ones of tube pinholes 252. The user passes respective ones of piston pins 238 through respective ones of pinholes 274, and into respective ones of piston pin bores 250. The user inserts respective ones of piston pins 238 through respective ones of pinholes 276, and into respective ones of piston pin bores 250. The user inserts respective ones of tube pins 236 into respective ones of tube pin bores 226, and into respective ones of piston pinholes 252. The user fastens first longitudinal half 270 to second longitudinal half 272, for example, by welding, brazing, by employing an adhesive, and the like. The user places spring 232 on cap 216, and assembles retaining ring 234 on retaining ring groove 240.

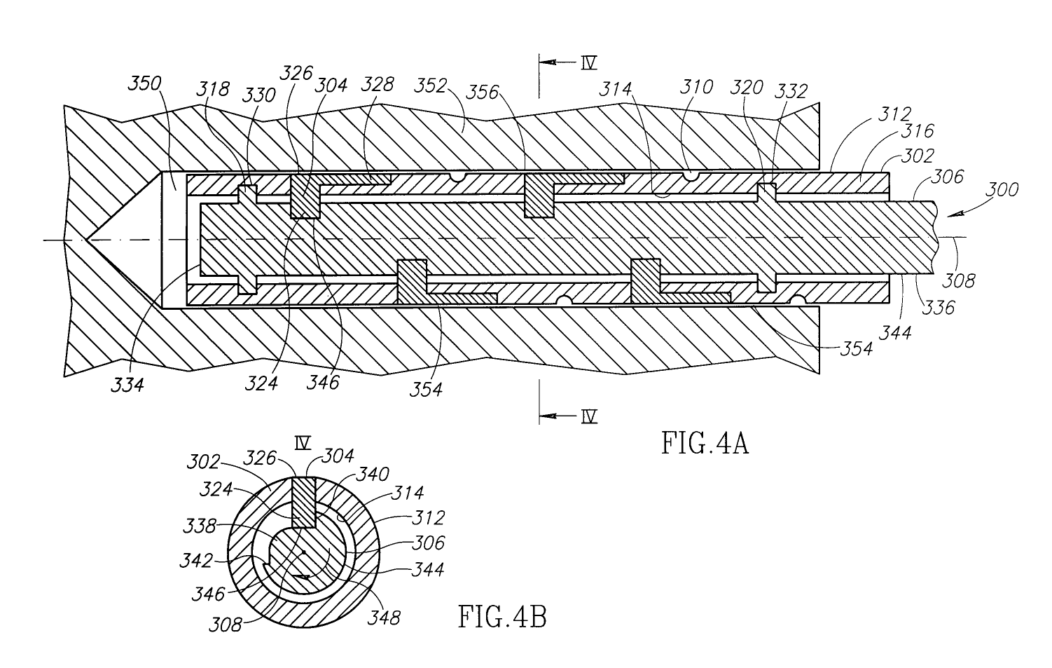

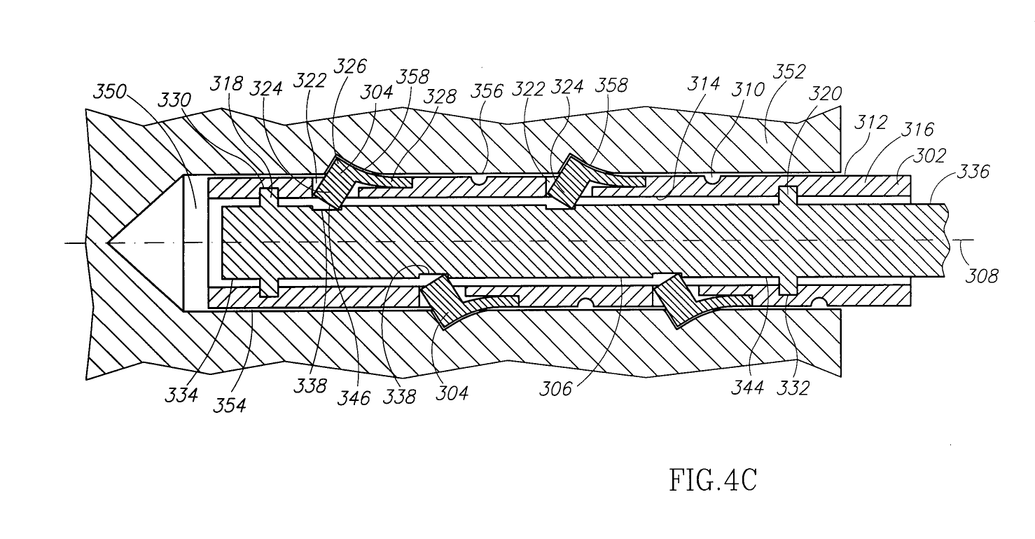

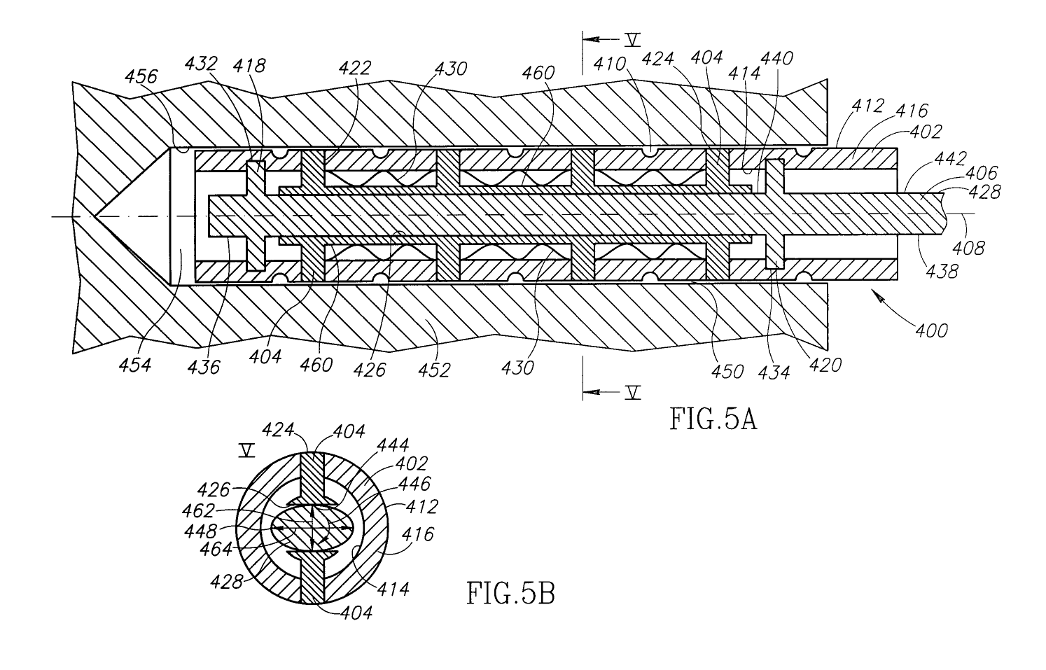

Reference is now made to FIGS. 4A, 4B and 4C. FIG. 4A is a schematic illustration of a nibbling mechanism generally referenced 300, in a pre-nibbling mode, constructed and operative according to a further embodiment of the disclosed technique. FIG. 4B is a schematic illustration of a cross section (cross section IV) of the nibbling mechanism of FIG. 4A. FIG. 4C is a schematic illustration of the nibbling mechanism of FIG. 4A in a nibbling mode.

With reference to FIG. 4A, nibbling mechanism 300 includes a tube 302, a plurality of cutters 304, a cutter moving mechanism 306 and a longitudinal axis 308. Tube 302 includes a helical groove 310, an outer surface 312, an inner surface 314, a wall 316, a front bearing 330, a rear bearing 332 and a plurality of openings 322. Each of cutters 304 includes a solid portion 324, a cutting portion 326 and a spring portion 328. Cutter moving mechanism 306 includes a front journal 318, a rear journal 320, a front end 334, a rear end 336, a plurality of eccentric surfaces 338 (FIG. 4B), a first set of stop surfaces 340, a second set of stop surfaces 342 and an outer surface 344.

Cutter moving mechanism 306 is in the form of a rod. Tube 302 and cutter moving mechanism 306 share the same longitudinal axis 308. Helical groove 310 is located on outer surface 312. Each of front journal 318 and rear journal 320 is located within wall 316. Each of openings 322 is located within wall 316. A diameter (not shown) of cutter moving mechanism 306 is smaller than an inner diameter (not shown) of tube 302. Cutter moving mechanism 306 is located within tube 302. Front bearing 330 is located within front journal 318. Rear bearing 332 is located within rear journal 320. Cutter moving mechanism 306 can rotate within tube 302. Alternatively, nibbling mechanism 300 can be devoid of front bearing 330, rear bearing 332, front journal 318 and rear journal 320. Instead, a diameter (not shown) of outer surface 344 is substantially equal to or less than a diameter (not shown) of inner surface 314, such that cutter moving mechanism 306 can freely rotate within tube 302.

Each of eccentric surfaces 338 is in the form of a longitudinal depression within outer surface 344. Each of first set of stop surfaces 340 and second set of stop surfaces 342 is substantially parallel with longitudinal axis 308. Each of eccentric surfaces 338 is located between a respective one of first set of stop surfaces 340 and a respective one of second set of stop surfaces 342. A first radius (not shown) of each one of eccentric surfaces 338 measured from longitudinal axis 308 to a respective one of first set of stop surfaces 340, is smaller than a second radius (not shown) of each one of eccentric surfaces 338 measured from longitudinal axis 308 to a respective one of second set of stop surfaces 342.

Each of spring portions 328 is in the form of a leaf spring. Each one of solid portions 324 can be in the form of a cube, and the like. Cutting portion 326 is coupled with solid portion 324, adjacent to spring portion 328. Each of spring portions 328 is coupled with outer surface 312, such that each of cutting portions 326 is located on outer surface 312, and each of solid portions 324 is located within respective ones of openings 322. Each of spring portions 328 is coupled with outer surface 312, for example, by welding, brazing, an adhesive and the like. Each of solid portions 324 includes a pressure surface 346, opposite a respective one of cutting portions 326. The spring force of each of spring portions 328 forces a respective one of pressure surfaces 346 against a respective one of eccentric surfaces 338.

When each of pressure surfaces 346 is located at a respective one of first set of stop surfaces 340, a respective one of cutting portions 326 and spring portions 328 is substantially aligned, or flush, with outer surface 312, and cutters 304 are at a retracted position. When cutter moving mechanism 306 rotates in a direction designated by an arrow 348 (FIG. 4B), rotation of a respective one of eccentric surfaces 338 forces a respective one of solid portions 324 away from longitudinal axis 308, against the spring force of a respective one spring portions 328. As cutter moving mechanism 306 continues to rotate in direction 348, each of eccentric surfaces 338 forces a respective one of cutters 304 away from longitudinal axis 308. When a respective one of solid portions 324 makes contact with a respective one of second set of stop surfaces 342, each of cutters 304 reaches an extreme extension position, where a distance (not shown) of each of cutting portions 326 from longitudinal axis 308 is at its maximum. When cutter moving mechanism 306 rotates in the opposite direction, the spring force of respective ones of spring portions 328 forces a respective one of cutters 304 toward longitudinal axis 308, until each of cutters 304 reaches a respective one of first set of stop surfaces 340 and its retracted position.

Following is a description of a method for preparing a cavity 350 (FIG. 4C) with a plurality of depressions within a construction material 352. The user drills a cylindrical hole 354 in construction material 352, with the aid of a power drill (not shown), as known in the art. With reference to FIG. 4A, the user inserts rear end 336 in a chuck (not shown) of a power drill (not shown), and inserts nibbling mechanism 300 into cylindrical hole 354. When the power drill rotates cutter moving mechanism 306 in direction 348, due to the friction between outer surface 312 and an inner surface 356 of cylindrical hole 354, cutter moving mechanism 306 rotates relative to tube 302, and each of eccentric surfaces 338 forces a respective one of cutters 304 away from longitudinal axis 308. Each of cutters 304 protrudes from outer surface 312 and carves a respective depression 358 in construction material 352. As mentioned above, compressed air can be used while using nibbling mechanism 300 to force dust and debris out of cavity 350 (FIG. 4A). Compressed air can be introduced into nibbling mechanism 300 while nibbling mechanism 300 is in use by providing the compressed air to the space between cutter moving mechanism 306 and tube 302 (as shown in FIGS. 4A and 4B). In addition, as mentioned above, cutter moving mechanism 306 can be produced as a hollow cutter moving mechanism (not shown) and may include lengthwise holes along the wall of the cutter moving mechanism. As the power drill rotates nibbling mechanism 300 in reverse, cutter moving mechanism 306 rotates in a direction opposite to the direction of arrow 348, and each of cutters 304 moves toward longitudinal axis 308 until it reaches a respective one of first set of stop surfaces 340 and its retracted position. At the retracted position, each of cutting portions 326 is aligned with outer surface 312 and the user can withdraw nibbling mechanism 300 from cavity 350.

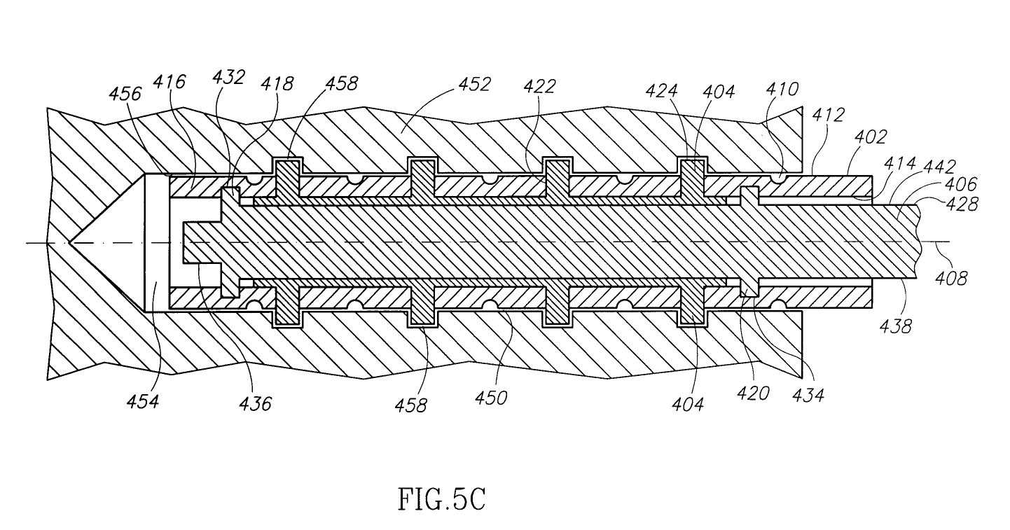

Reference is now made to FIGS. 5A, 5B and 5C. FIG. 5A is a schematic illustration of a nibbling mechanism generally referenced 400, in a pre-nibbling mode, constructed and operative according to another embodiment of the disclosed technique. FIG. 5B is a schematic illustration of a cross section (cross section V) of the nibbling mechanism of FIG. 5A. FIG. 5C is a schematic illustration of the nibbling mechanism of FIG. 5A in a nibbling mode. Nibbling mechanism 400 includes a tube 402, a plurality of cutters 404, a cutter moving mechanism 406 and a longitudinal axis 408. Tube 402 includes a helical groove 410, a tube outer surface 412, a tube inner surface 414, a wall 416, a front bearing 432, a rear bearing 434 and a plurality of openings 422. Each of cutters 404 is in the form of an elongated object. Each of cutters 404 includes a plurality of cutting edges 424, a plurality of cutter outer surfaces 460 and a cutter inner surface 426. Cutter moving mechanism 406 includes a rod 428 and a plurality of springs 430. Rod 428 includes a front journal 418, a rear journal 420, a front end 436, a rear end 438, a curved portion 440 and a cylindrical portion 442.

Helical groove 410 is located on tube outer surface 412. Openings 422 are located within wall 416. Rod 428 is located within tube 402. Tube 402 and rod 428 share the same longitudinal axis 408. Front bearing 432 is located within front journal 418. Rear bearing 434 is located within rear journal 420. Rod 428 can rotate within tube 402. A curved portion longitudinal axis (not shown) of curved portion 440 lies substantially along longitudinal axis 408. A cross section (FIG. 5B) of curved portion 440 has a first curved portion axis 462 and a second curved portion axis 464. A length of second curved portion axis 464 is larger than a length of first curved portion axis 462. First curved portion axis 462 defines a low elevation portion 444 of curved portion 440. Second curved portion axis 464 defines a high elevation portion 448 of curved portion 440. The cross section of curved portion 440 can be for example in form of an ellipse and the like. Cutters 404 are located between tube inner surface 414 and curved portion 440. Each of springs 430 can be for example in the form of a wave spring and the like. Each of springs 430 is located between a respective one of cutter outer surfaces 460 and tube inner surface 414. Cutting edges 424 can slide within respective ones of openings 422, in a direction perpendicular to longitudinal axis 408, toward and away from longitudinal axis 408.

Each set of springs 430 applies a spring force on a respective one of cutters 404 toward longitudinal axis 408, such that the respective cutter inner surface 426 makes contact with curved portion 440. In a pre-nibbling mode, each of cutter inner surfaces 426 is forced by the spring force to rest on low elevation portion 444 and cutting edges 424 are substantially aligned with tube outer surface 412. In the pre-nibbling mode, a distance (not shown) between each of cutter inner surfaces 426 and longitudinal axis 408 is at a minimum. When rod 428 rotates in a direction designated by an arrow 446, each of cutter inner surfaces 426 slides on curved portion 440 against the spring force of a respective one of springs 430. The distance between the respective cutter inner surface 426 and longitudinal axis 408 then increases until cutter inner surface 426 reaches high elevation portion 448, thereby moving nibbling mechanism 400 toward a nibbling position. As rod 428 continues to rotate in the direction of arrow 446, each of cutters 404 moves away from longitudinal axis 408, and each of cutting edges 424 slides within a respective opening 422 to protrude from the respective opening 422. As rod 428 continues to rotate in the direction of arrow 446, the spring force forces each of cutters 404 toward longitudinal axis 408, and each of cutting edges 424 slides within a respective opening 422 to retract within the respective opening 422.

Following is a description of a method for preparing a cavity 450 (FIG. 5C) with a plurality of depressions within a construction material 452. The user drills a cylindrical hole 454 in construction material 452, with the aid of a power drill (not shown) as known in the art. With reference to FIG. 5A, the user inserts rear end 438 in a chuck (not shown) of a power drill (not shown), and inserts nibbling mechanism 400 into cylindrical hole 454. When the power drill rotates rod 428 in the direction of arrow 446, due to the friction between tube outer surface 412 and an inner surface 456 of cylindrical hole 454, rod 428 rotates relative to tube 402. Each of cutting edges 424 protrudes from tube outer surface 412 and carves a depression 458 within construction material 452. As mentioned above, compressed air can be used while using nibbling mechanism 400 to force dust and debris out of cylindrical hole 454 (FIG. 5A). Compressed air can be introduced into nibbling mechanism 400 while nibbling mechanism 400 is in use by providing the compressed air to the space between cutter moving mechanism 406 and tube 402 (as shown in FIGS. 5A and 5B). In addition, as mentioned above, cutter moving mechanism 406 can be produced as a hollow cutter moving mechanism (not shown) and may include lengthwise holes along the wall of the cutter moving mechanism. The power drill rotates rod 428 such that the spring force of springs 430 forces cutters 404 toward longitudinal axis 408, and cutting edges 424 are aligned with tube outer surface 412, thereby allowing the user to withdraw nibbling mechanism 400 from cavity 450.

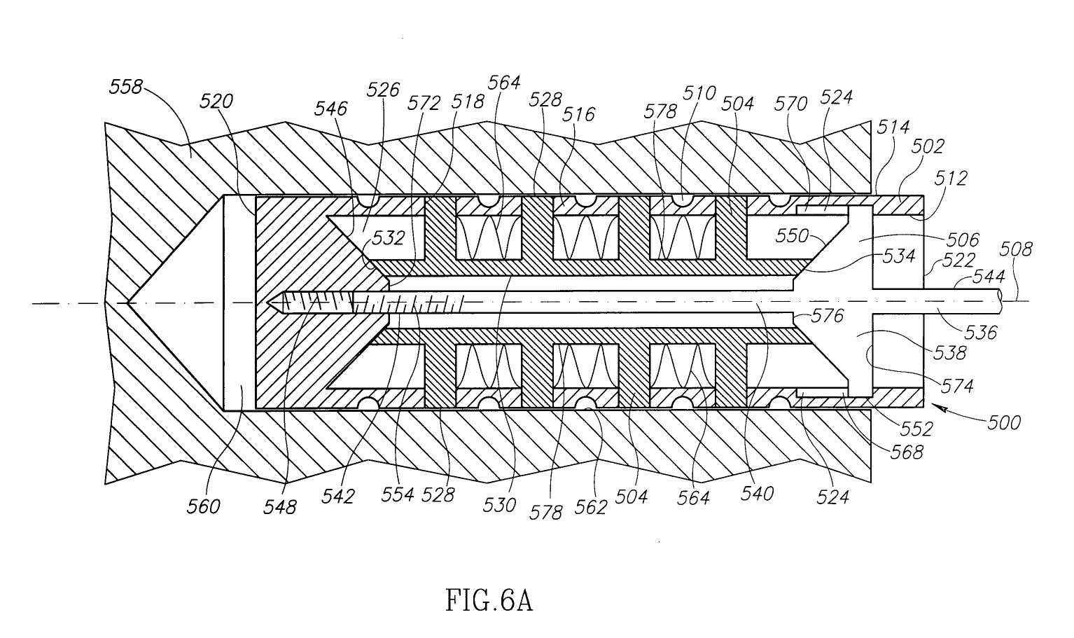

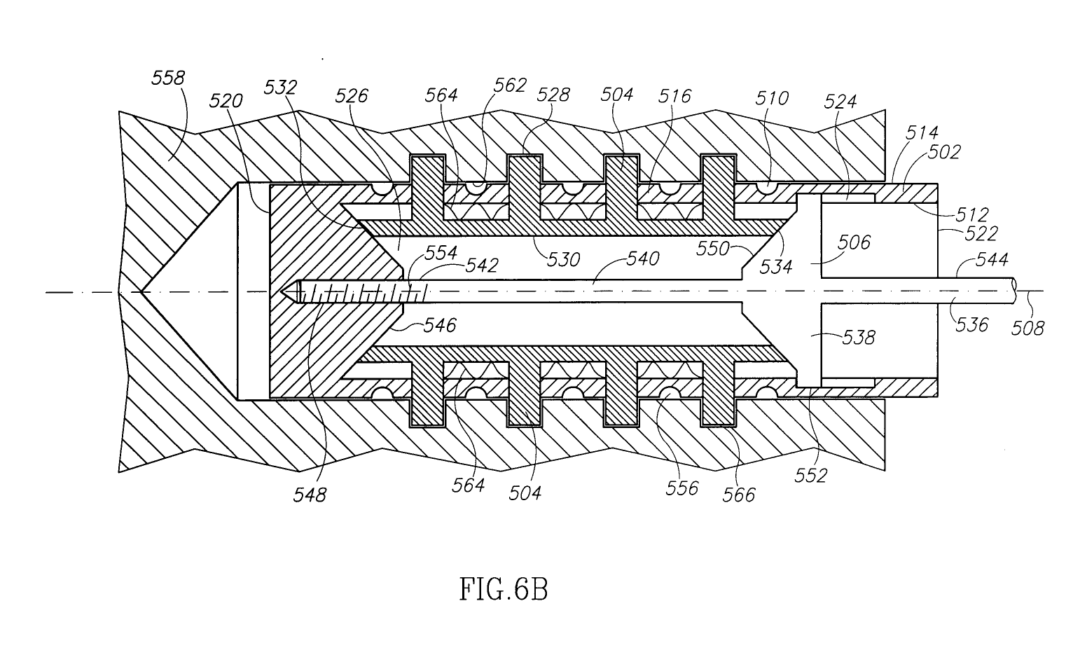

Reference is now made to FIGS. 6A, and 6B. FIG. 6A is a schematic illustration of a nibbling mechanism generally referenced 500, in a pre-nibbling mode, constructed and operative according to a further embodiment of the disclosed technique. FIG. 6B is a schematic illustration of the nibbling mechanism of FIG. 6A in a nibbling mode. Nibbling mechanism 500 includes a tube 502, a plurality of cutters 504, a cutter moving mechanism 506 and a longitudinal axis 508. Tube 502 includes a helical groove 510, a tube inner surface 512, a tube outer surface 514, a wall 516, a plurality of openings 518, a front end 520, a rear end 522, a plurality of linear bearings 524 and a conical portion 526. Each of cutters 504 includes a plurality of cutting edges 528, a linear portion 530, a front guiding surface 532, a rear guiding surface 534 and a plurality of cutter outer surfaces 578. Cutter moving mechanism 506 includes a cylindrical portion 536, a conical portion 538, a threaded portion 540, a front end 542, a rear end 544 and a plurality of springs 564. Conical portion 526 includes a conical surface 546 and an internal thread 548. A base (not shown) of conical portion 526 is located at front end 520. An apex 572 of conical portion 526 is located between front end 520 and rear end 522. Conical portion 538 includes a conical surface 550, a plurality of spikes 552 and an external thread 554.

Helical groove 510 is located on tube outer surface 514. Openings 518 are located within wall 516. Each of linear bearings 524 is located within tube inner surface 512 at rear end 522. Each of linear bearings 524 is in the form of an arc of a circle along a perimeter (not shown) of tube inner surface 512. Conical portion 526 is located at front end 520 and coupled with tube 502. Cylindrical portion 536 is located at rear end 544. Conical portion 538 is located at rear end 544, between cylindrical portion 536 and threaded portion 540. External thread 554 is located at front end 542. The screw thread parameters of internal thread 548 are substantially identical with that of external thread 554. Tube 502 and cutter moving mechanism 506 share the same longitudinal axis 508.

Cutter moving mechanism 506 is located within tube 502. Each of spikes 552 is located within the corresponding linear bearing 524. Each of spikes 552 is located at a base 574 of conical portion 538. An apex 576 of conical portion 538 is located between base 574 and external thread 554. Incorporating each of spikes 552 with the corresponding one of linear bearings 524 allows cutter moving mechanism 506 to rotate about longitudinal axis 508 and move along longitudinal axis 508, from front end 520 toward rear end 522 and back. External thread 554 is screwed into internal thread 548. Each of cutting edges 528 is located within respective ones of openings 518, and can slide there within, in a direction from tube inner surface 512 toward tube outer surface 514 and back. A first apex (not shown) of conical surface 546 and a second apex (not shown) of conical surface 550, are located between conical surface 546 and conical surface 550. Front guiding surface 532 is in contact with conical surface 546. Rear guiding surface 534 is in contact with conical surface 550. Each set of springs 564 are located between cutter outer surfaces 578 of a respective one of cutters 504 and tube inner surface 512. Each of springs 564 can be in the form of a leaf spring and the like, which applies a spring force on each of cutters 504, to force cutters 504 to move from tube inner surface 512, toward longitudinal axis 508, and for front guiding surface 532 to make contact with conical surface 546, and rear guiding surface 534 to make contact with conical surface 550. In the pre-nibbling mode illustrated in FIG. 6A, the distance (not shown) between apex 572 and apex 576 is such that cutting edges 528 are substantially aligned with tube outer surface 514.

Following is a description of a method for preparing a cavity 556 (FIG. 6B) with a plurality of depressions within a construction material 558. The user drills a cylindrical hole 560 in construction material 558, with the aid of a power drill (not shown) as known in the art. With reference to FIG. 6A, the user inserts cylindrical portion 536 in a chuck (not shown) of a power drill (not shown), and inserts nibbling mechanism 500 into cylindrical hole 560. The power drill rotates cutter moving mechanism 506. Since conical portion 526 is coupled with tube 502 and due to the friction between tube outer surface 514 and an inner wall 562 of cylindrical hole 560, tube 502 remains substantially stationary relative to cutter moving mechanism 506, and external thread 554 screws into internal thread 548. In this manner the distance between apex 572 and apex 576 decreases, and cutter moving mechanism 506 and conical portion 538 move toward conical portion 526, from rear end 522 toward front end 520.

An arc length of each of linear bearings 524 is of such a value, that as external thread 554 screws into internal thread 548, and conical portion 538 rotates, each of spikes 552 rotates within a corresponding linear bearing 524 and slides within the corresponding linear bearing 524 toward conical portion 526. Each of spikes 552 moves from a rear end 568 of the corresponding linear bearing 524, toward a front end 570 of the corresponding linear bearing 524. When each of spikes 552 makes contact with front end 570 of the corresponding linear bearing 524, cutter moving mechanism 506 can no longer rotate within tube 502, thereby forcing tube 502 together with cutters 504, to rotate within cylindrical hole 560. This movement forces front guiding surface 532 and rear guiding surface 534 to slide on conical surface 546 and conical surface 550, respectively, against the spring force of each of springs 564, thereby causing each of cutters 504 to move away from longitudinal axis 508. Therefore, cutting edges 528 slide through respective ones of openings 518 from tube inner surface 512 toward tube outer surface 514, to protrude from tube outer surface 514.

The power drill rotates nibbling mechanism 500, and each of cutting edges 528 carves a depression 566 within construction material 558 to form cavity 556. As mentioned above, compressed air can be used while using nibbling mechanism 500 to force dust and debris out of cavity 556 (FIG. 6B). Compressed air can be introduced into nibbling mechanism 500 while nibbling mechanism 500 is in use by providing the compressed air to the space between threaded portion 540 and linear portion 530 (as shown in FIGS. 6A and 6B). In addition, as mentioned above, cutter moving mechanism 506, in particular threaded portion 540, can be produced as a hollow cutter moving mechanism (not shown) and may include lengthwise holes along the wall of the threaded portion. The reverse rotation of the power drill causes cutter moving mechanism 506 to rotate in reverse and external thread 554 to unscrew, thereby moving cutter moving mechanism 506 from front end 520 toward rear end 522. The spring force of each of springs 564 forces each of cutters 504 to move from tube inner surface 512 toward longitudinal axis 508, and for each of cutting edges 528 to retract back within the respective opening 518, and to be aligned with tube outer surface 514, thereby allowing the user to withdraw nibbling mechanism 500 from cavity 556.

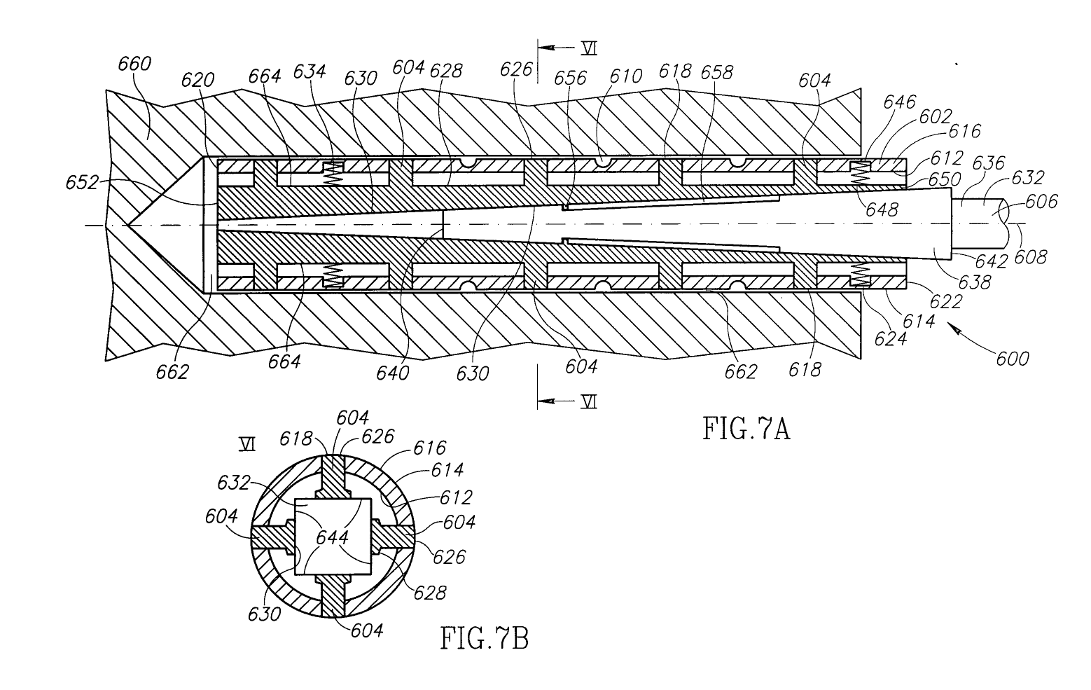

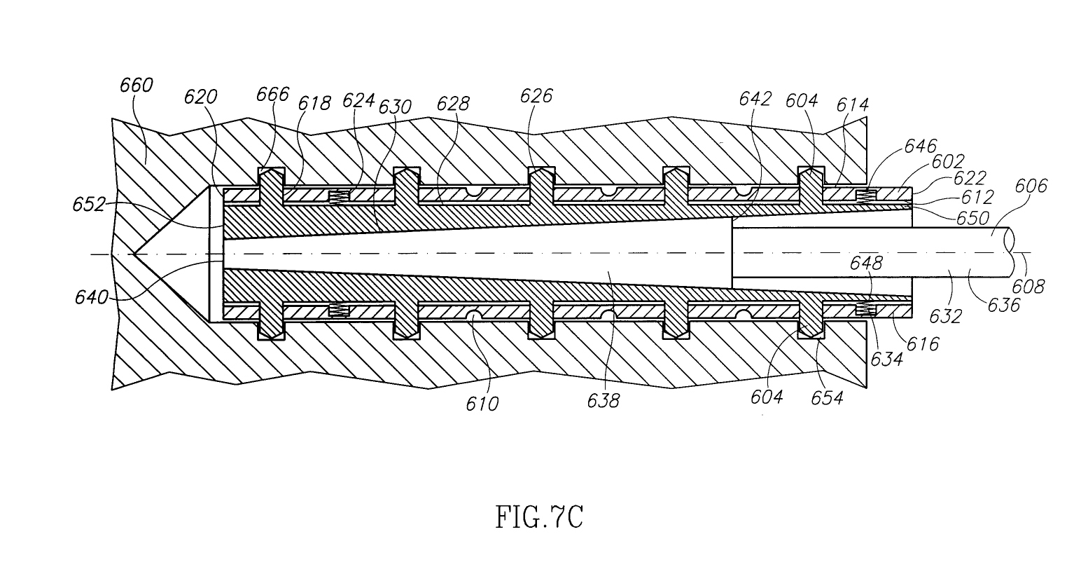

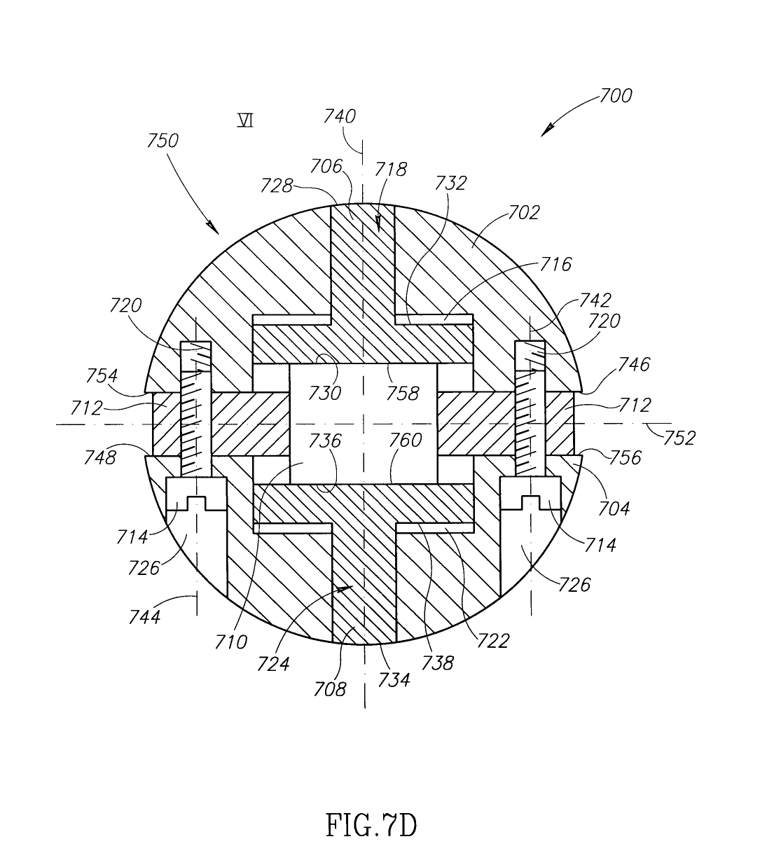

Reference is now made to FIGS. 7A, 7B, 7C and 7D. FIG. 7A is a schematic illustration of a nibbling mechanism, generally referenced 600, in a pre-nibbling mode, constructed and operative according to another embodiment of the disclosed technique. FIG. 7B is a schematic illustration of a cross section (i.e., cross section VI) of the nibbling mechanism of FIG. 7A. FIG. 7C is a schematic illustration of the nibbling mechanism of FIG. 7A, in a nibbling mode. FIG. 7D is a schematic illustration of a cross section (i.e., cross section VI) of a nibbling mechanism, generally referenced 700, similar to the nibbling mechanism of FIG. 7A, according to another embodiment of the disclosed technique.

Nibbling mechanism 600 includes a tube 602, a plurality of cutters 604, a cutter moving mechanism 606 and a longitudinal axis 608. Tube 602 includes a helical groove 610, a tube inner surface 612, a tube outer surface 614, a wall 616, a plurality of openings 618, a tube front end 620, a tube rear end 622 and a plurality of depressions 624. Each of cutters 604 includes a plurality of cutting edges 626, a curved portion 628, a substantially flat portion 630 and a plurality of cutter outer surfaces 664. Cutter moving mechanism 606 includes a shaft 632 and a plurality of springs 634. Shaft 632 includes a power drill attachment portion 636 and a polygonal portion 638. Polygonal portion 638 includes a front end 640, a rear end 642 and a plurality of substantially flat surfaces 644. Helical groove 610 is located on tube outer surface 614. Openings 618 are located within wall 616. Depressions 624 are located within wall 616. A first end 646 of each of springs 634 is located within respective ones of depressions 624, and a second end 648 of each of springs 634 makes contact with curved portion 628, such that springs 634 force each of cutters 604 toward longitudinal axis 608. In the pre-nibbling mode illustrated in FIG. 7A, cutting edges 626 are substantially aligned with tube outer surface 614.

A cross section of polygonal portion 638 can be in the form of a polygon, such as a square, a rectangle, a triangle, a pentagon, a hexagon and the like. In the example illustrated in FIG. 7B, the cross section of polygonal portion 638 is in the form of a square and therefore cutters 604 are four in number. Polygonal portion 638 is in the form of a frustum of a pyramid, wherein the apex of the pyramid is located at front end 640 and the base of the pyramid is located at rear end 642. A rear end 650 of each of cutters 604 is thinner than a front end 652 of cutter 604, such that substantially flat portion 630 is in the form of a sloped surface whose slope substantially matches the slope of the pyramid of polygonal portion 638. Substantially flat portion 630 is in the form of a sloped surface relative to longitudinal axis 608.

Each of substantially flat portions 630 makes contact with the respective one of substantially flat surfaces 644. Each of springs 634 applies a spring force on respective ones of cutter outer surfaces 664, for the respective cutter 604 to move toward polygonal portion 638, and for the respective one of substantially flat portions 630 to make contact with the respective one of substantially flat surfaces 644. Power drill attachment portion 636 is located at rear end 642. The cross section of power drill attachment portion 636 is in a shape which matches the opening of a chuck (not shown) of the power drill, such as a circle, a square, a rectangle and the like.

In a nibbling mode (FIG. 7C), when shaft 632 moves from tube rear end 622 toward tube front end 620, relative to substantially flat portions 630, each of cutters 604 moves away from longitudinal axis 608 against the spring forces, and the respective set of cutting edges 626, protrude from respective ones of openings 618. When shaft 632 moves from tube front end 620 back toward tube rear end 622, the spring forces force substantially flat surfaces 644 to slide on substantially flat portions 630, thereby moving each of cutters 604 from tube outer surface 614 back toward longitudinal axis 608, and for cutting edges 626 to retract within the respective openings 618. Additionally, each of cutters 604 can include a protrusion 656 (shown in FIG. 7A) protruding from respective ones of substantially flat portions 630. Polygonal portion 638 includes a plurality of grooves 658 (shown in FIG. 7A). The dimension of each of protrusions 656 is substantially the same as a width (not shown) of grooves 658. Protrusions 656 and grooves 658 prevent shaft 632 from moving out of tube 602 completely. Protrusions 656 also enable shaft 632 to retract nibbling mechanism 600 from cylindrical hole 662 as shaft 632 is withdrawn from cavity 654.

Following is a description of a method for preparing a cavity 654 (FIG. 7C) with a plurality of depressions within a construction material 660. The user drills a cylindrical hole 662 in construction material 660, with the aid of a power drill (not shown) as known in the art. With reference to FIG. 7A, the user inserts power drill attachment portion 636 in the chuck of the power drill, and inserts nibbling mechanism 600 into cylindrical hole 662. The power drill rotates polygonal portion 638, and a force acting between each of substantially flat portions 630 and respective ones of substantially flat surfaces 644, causes tube 602 to rotate along with cutters 604, within cylindrical hole 662. A force applied by the user (not shown) on shaft 632 along longitudinal axis 608, toward tube front end 620, causes a normal force to act between each of substantially flat portions 630 and respective ones of substantially flat surfaces 644, thereby forcing each of cutters 604 away from longitudinal axis 608, and toward tube outer surface 614, against the spring forces of springs 634. Therefore, cutting edges 626 slide through respective ones of openings 618 from tube inner surface 612 toward tube outer surface 614, to protrude from tube outer surface 614.

The power drill rotates nibbling mechanism 600, and each of cutting edges 626 carves a depression 666 within construction material 660 to form cavity 654. As mentioned above, compressed air can be used while using nibbling mechanism 600 to force dust and debris out of cavity 654 (FIG. 7C). Compressed air can be introduced into nibbling mechanism 600 while nibbling mechanism 600 is in use by providing the compressed air to the space between shaft 632 and tube inner surface 612 (as shown in FIG. 7B). In addition, as mentioned above, shaft 632 can be produced as a hollow shaft (not shown) and may include lengthwise holes along the wall of the hollow shaft. Pulling shaft 632 out of cavity 654, causes the spring forces of springs 634 to force each of cutters 604 to move from tube inner surface 612 back toward longitudinal axis 608, and for each of cutting edges 626 to move back toward tube inner surface 612 and to be aligned with tube outer surface 614, thereby allowing the user to withdraw nibbling mechanism 600 from cavity 654.

With reference to FIG. 7D, nibbling mechanism 700 includes a tube 750, a first cutter 706, a second cutter 708, a shaft 710, a plurality of spacers 712 and a plurality of bolts 714. Tube 750 includes a tube symmetric plane 752, a first longitudinal half 702 and a second longitudinal half 704. First longitudinal half 702 includes a first longitudinal cavity 716, a plurality of openings 718, a plurality of internal threads 720 and a first longitudinal half substantially flat surface 754. Second longitudinal half 704 includes a second longitudinal cavity 722, a plurality of openings 724, a plurality of bolt openings 726 and a second longitudinal half substantially flat surface 756. First cutter 706 includes a plurality of cutting edges 728, a first substantially flat slanted cutter surface 730 and a first substantially horizontal surface 732. Second cutter 708 includes a plurality of cutting edges 734, a second substantially flat slanted cutter surface 736 and a second substantially horizontal surface 738. Shaft 710 is substantially similar to shaft 632 (FIG. 7A). A cross section of shaft 710 is rectilinear (e.g., a square, a rectangle). Shaft 710 includes a first substantially flat slanted shaft surface 758 and a second substantially flat slanted shaft surface 760.

Each of cutting edges 728 protrudes in a direction substantially perpendicular to first substantially horizontal surface 732. First substantially flat slanted cutter surface 730 is located on the opposite side of cutting edges 728. Second cutter 708 is similar to first cutter 706. First longitudinal cavity 716 runs along a longitudinal axis (not shown) of tube 750. First longitudinal cavity 716 is located in first longitudinal half substantially flat surface 754. First longitudinal half substantially flat surface 754 is substantially parallel with tube symmetric plane 752. Tube symmetric plane 752 substantially intersects the longitudinal axis. Each of openings 718 is located along a thread symmetric plane 740. Tube symmetric plane 752 is substantially normal to thread symmetric plane 740. Second longitudinal cavity 722 runs along the longitudinal axis. Second longitudinal cavity 722 is located in second longitudinal half substantially flat surface 756. Second longitudinal half substantially flat surface 756 is substantially parallel with tube symmetric plane 752. A thread longitudinal axis 742 of a respective one of internal threads 720 is located substantially symmetrically, along a direction substantially perpendicular to the longitudinal axis. Each of openings 724 is located along thread symmetric plane 740. A bolt opening axis 744 of a respective one of bolt openings 726 is located substantially symmetrically, along a direction substantially perpendicular to the longitudinal axis. An external thread profile of each of bolts 714 is substantially the same as an internal thread profile of each of internal threads 720. A first slope of first substantially flat slanted cutter surface 730 is substantially the same as that of first substantially flat slanted shaft surface 758. A second slope of second substantially flat slanted cutter surface 736 is substantially the same as that of second substantially flat slanted shaft surface 760.

In order to assemble nibbling mechanism 700, bolts 714 are screwed into internal threads 720, while shaft 710 is located within longitudinal cavities 716 and 722, first cutter 706 is located on one side of shaft 710, second cutter 708 is located on the other side of shaft 710, and spacers 712 are located between a substantially flat horizontal surface 746 of first longitudinal half 702, and a substantially flat horizontal surface 748 of second longitudinal half 704, respectively. Movement of shaft 710 toward a leading edge (not shown) of nibbling mechanism 700, causes cutting edges 728 and 734, to move away from the longitudinal axis within openings 718 and 724, respectively.

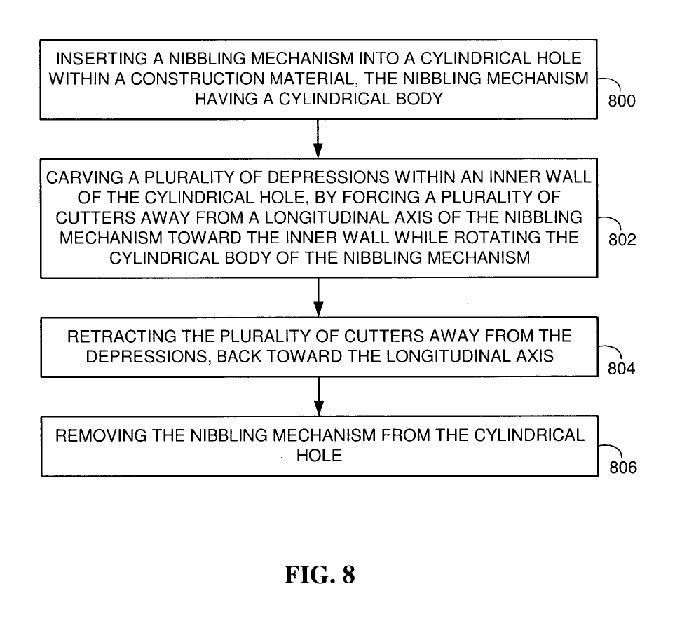

Reference is now made to FIG. 8, which is a schematic illustration of a method for producing depressions in a cavity within a construction material, for fixing an anchor in the cavity, operative according to another embodiment of the disclosed technique. The method of FIG. 8 assumes that a cylindrical hole has already been formed within a construction material. If a cylindrical hole within the construction material was not formed, then in a preliminary procedure before procedure 800, a cylindrical hole within the construction material is produced, for example, by using a power drill. In procedure 800, a nibbling mechanism is inserted in a cylindrical hole within a construction material, the nibbling mechanism having a cylindrical body. With reference to FIG. 2B, the user inserts nibbling mechanism 100 into cylindrical hole 162 of construction material 160. In procedure 802, a plurality of depressions are carved, or produced within an inner wall of the cylindrical hole, by forcing a plurality of cutters away from a longitudinal axis of the nibbling mechanism, toward the inner wall, while rotating the cylindrical body of the nibbling mechanism. With reference to FIG. 2C, cutters 104 carve depressions 180 (FIG. 2D) within inner wall 164 of cylindrical hole 162, by forcing cutters 104 away from longitudinal axis 142, and toward inner wall 164, while the user rotates rod 102 with the aid of the power drill.

In procedure 804, the plurality of cutters is retracted away from the depressions, back toward the longitudinal axis. With reference to FIGS. 2B and 2D, when the user releases the forward force on rod 102, spring 122 forces rod 102 from front end 110 toward rear end 108, thereby forcing cutters 104 away from cylindrical hole 162 and depressions 180, back toward longitudinal axis 142. In procedure 806, the nibbling mechanism is removed from the cylindrical hole. With reference to FIGS. 2B and 2D, in this manner, cutters 104 move back into openings 128, thereby clearing the way for nibbling mechanism to be removed from cavity 182. It is noted that after procedure 806, an anchor can be inserted into the cylindrical hole and can be coupled with the cylindrical hole using a settable material, as described above.

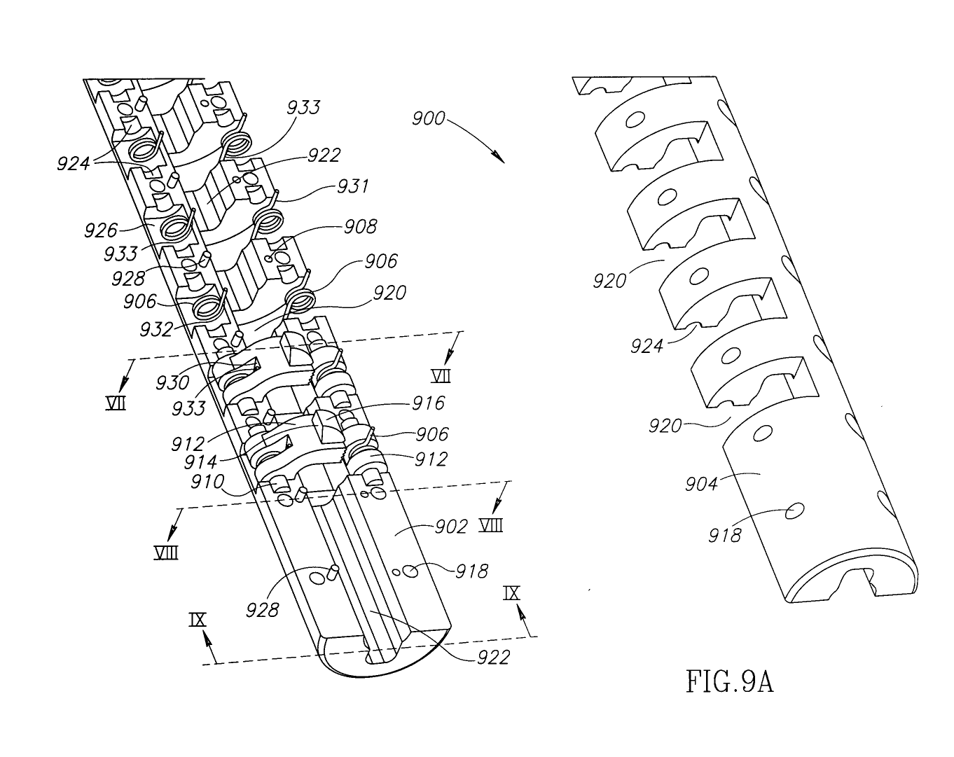

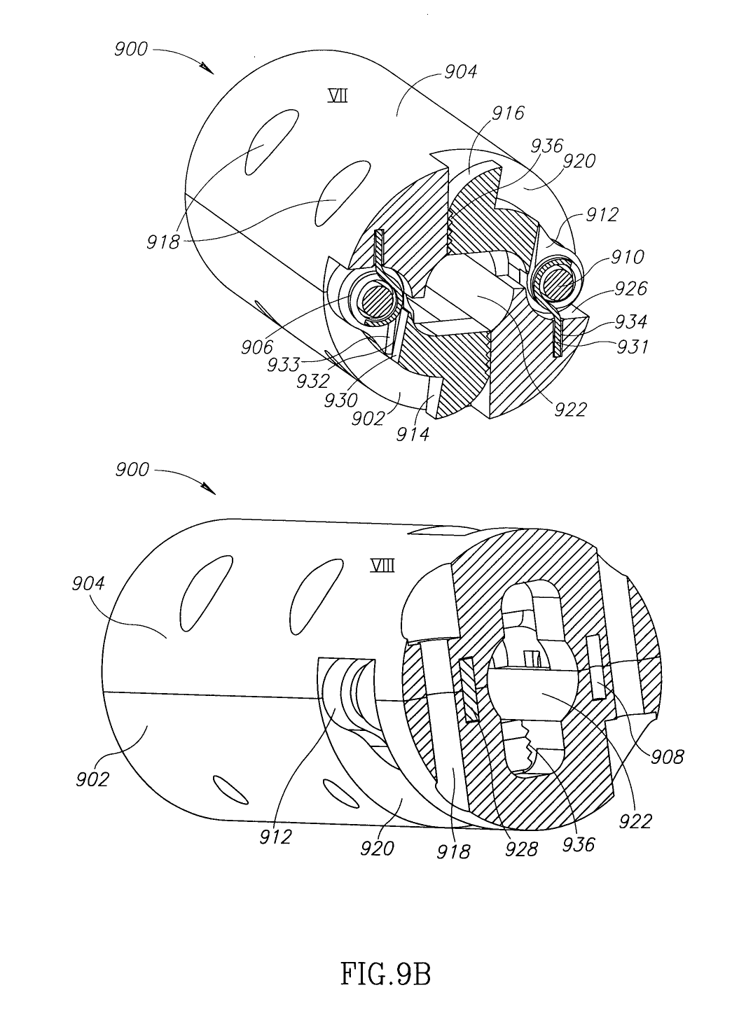

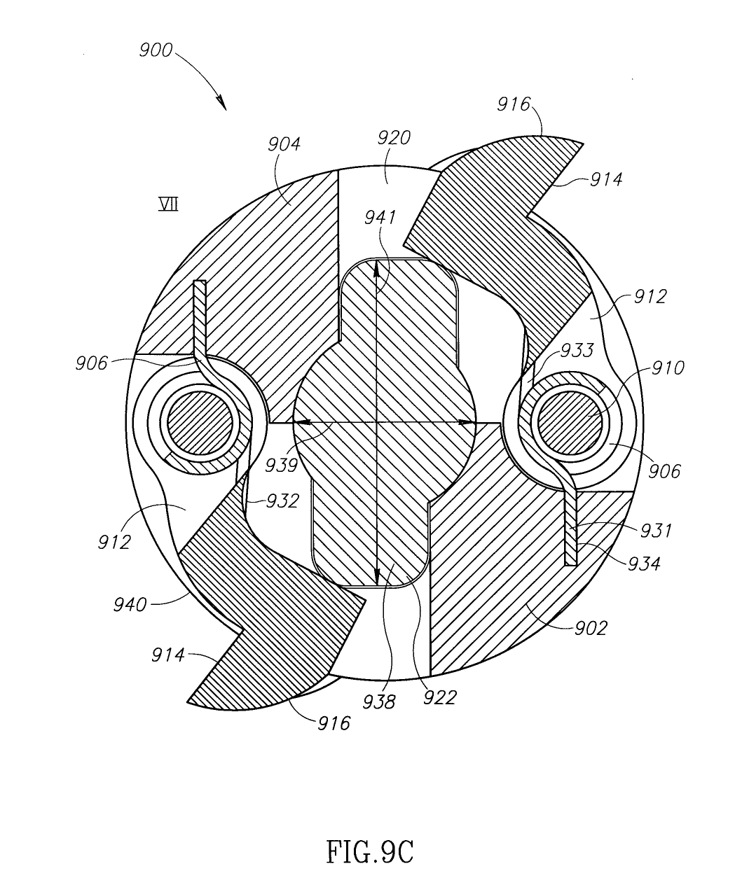

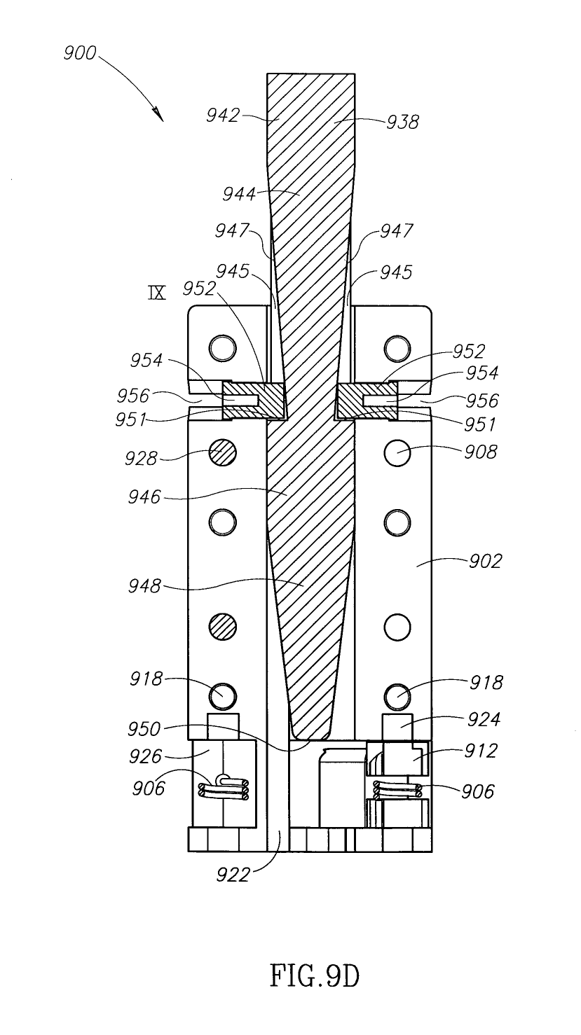

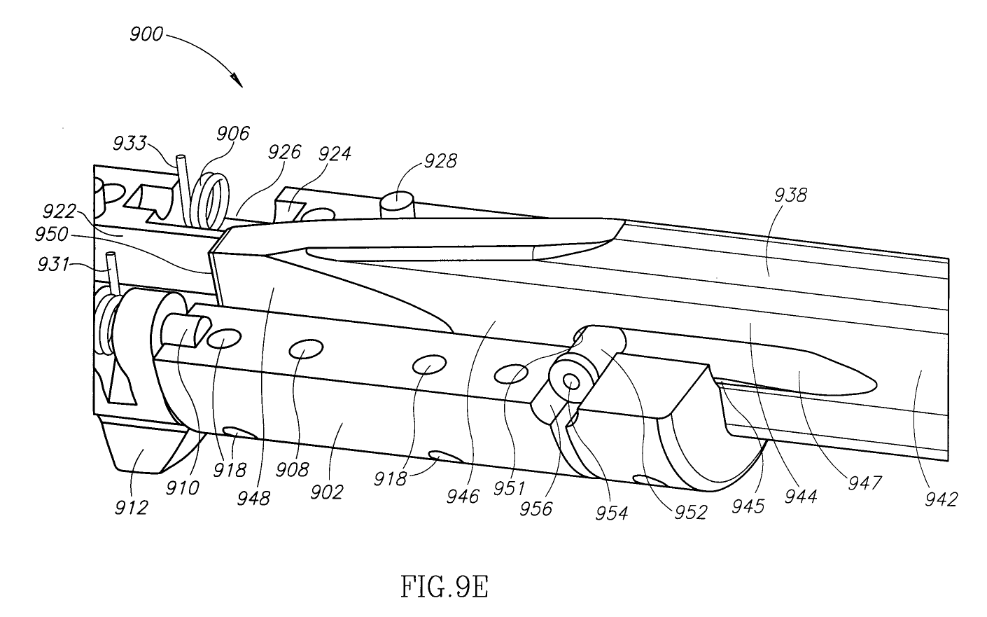

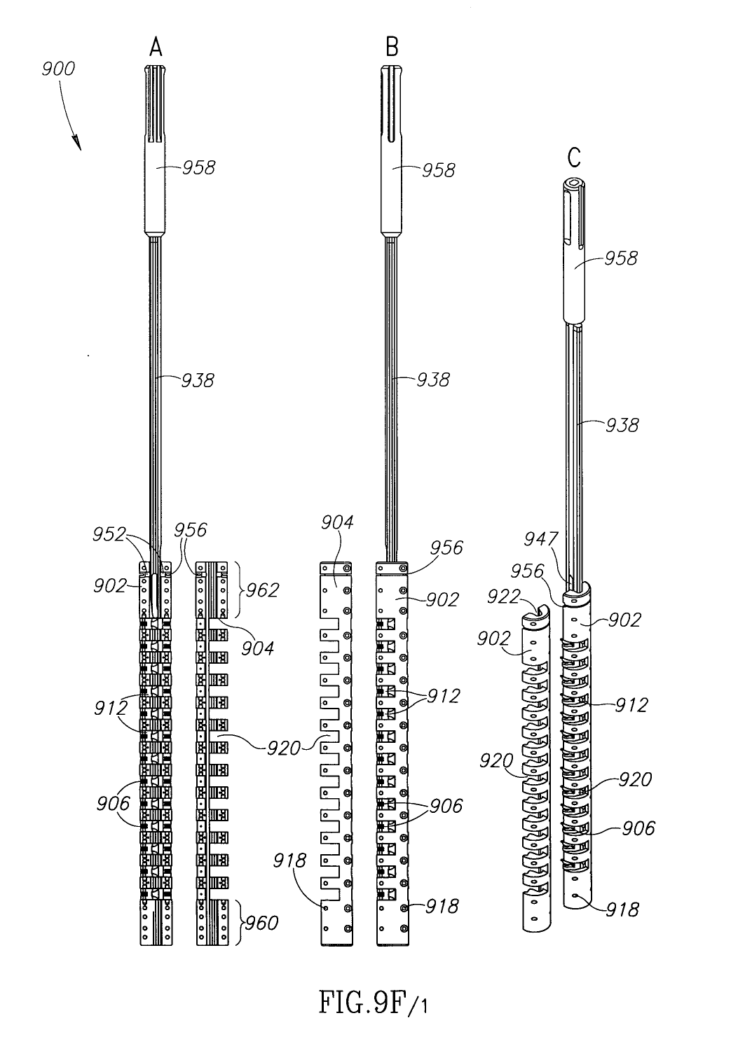

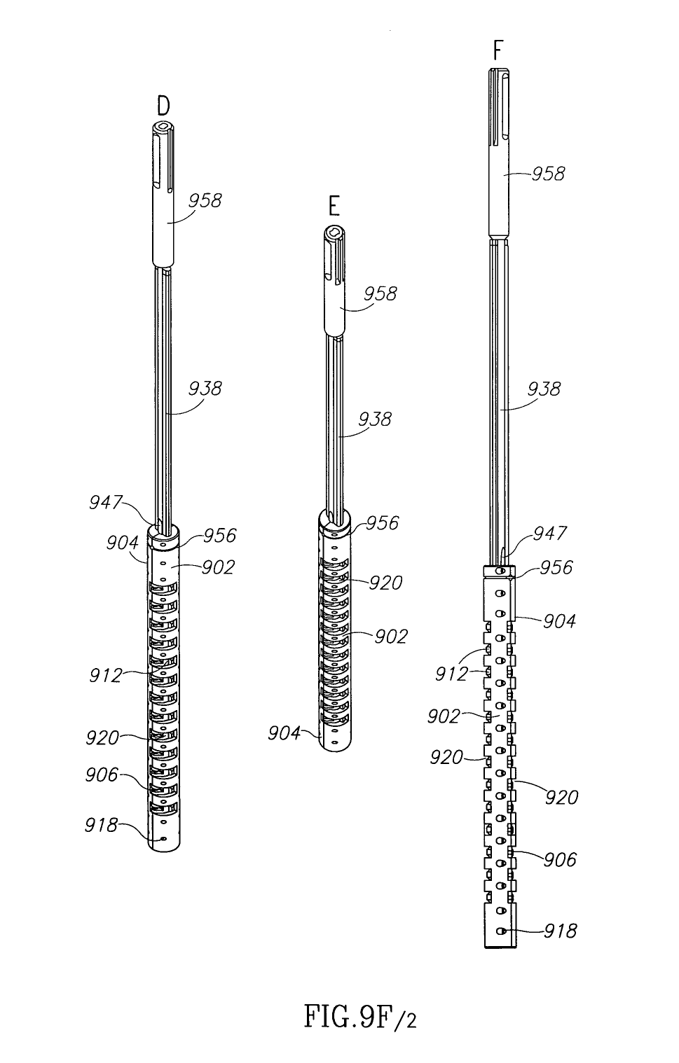

Reference is now made to FIGS. 9A, 9B, 9C, 9D, 9E, 9F_{/1} and 9F₂. FIG. 9A is a schematic illustration of a nibbling mechanism in a pre-nibbling mode, shown in an exploded view, generally referenced 900, constructed and operative according to a further embodiment of the disclosed technique. FIG. 9B is a schematic illustration of two cross sections (i.e., cross sections VII and VIII) of the nibbling mechanism of FIG. 9A, shown in an assembled perspective view. FIG. 9C is a schematic illustration of a cross section (i.e., cross section VII) of the nibbling mechanism of FIG. 9A, in a nibbling mode. FIG. 9D is a schematic illustration of a cross section (i.e., cross section IX) of the nibbling mechanism of FIG. 9A, in a pre-nibbling mode. FIG. 9E is a schematic illustration of the cross section of FIG. 9D in a perspective view. FIGS. 9F_{/1} and 9F_{/2} are schematic illustrations of the nibbling mechanism of FIG. 9A, including a cutter moving mechanism, shown in various perspective and orthogonal views labeled A, B, C, D, E and F.

Reference is now made to FIG. 9A, which is an exploded view of nibbling mechanism 900 in a pre-nibbling mode. Nibbling mechanism 900 includes a first element 902 and a second element 904. First element 902 includes a plurality of springs 906, a plurality of alignment pinholes 908, a plurality of hinges 910, a plurality of cutters 912, a plurality of screw holes 918, a plurality of openings 920, a hollow 922, a plurality of hinge spaces 924, a plurality of cutter spaces 926 and a plurality of alignment pins 928. Similar elements are shown on second element 904. Each one of plurality of springs 906 respectively includes a coupling end 931 and a force exerting end 933. Each one of plurality of cutters 912 respectively includes a cutting surface 914, a curved surface 916 and a flat surface 930.

Hollow 922 extends over the length of first element 902 and second element 904. In an assembled view (as shown in FIG. 9B), first element 902 and second element 904 are coupled together thereby forming a nibbling mechanism. Alignment pinholes 908 are located along the length of first element 902 and second element 904. In one embodiment, alignment pinholes 908 are substantially evenly spaced between plurality of openings 920. Alignment pins 928 are inserted into alignment pinholes 908 to align first element 902 with second element 904 when first element 902 is to be coupled with second element 904. In one embodiment of the disclosed technique, at least two alignment pinholes and alignment pins are necessary in first element 902 and second element 904. Plurality of screw holes 918 are also located along the length of first element 902 and second element 904. In one embodiment, plurality of screw holes 918 is substantially evenly spaced between plurality of openings 920. In one embodiment of the disclosed technique, each screw hole 918 is substantially adjacent to a respective alignment pinhole 908. Screw holes 918 enable first element 902 to be securely coupled with second element 904 via screws (not shown), bolts (not shown), pins (not shown) or other fastening elements (also not shown). In one embodiment, screw holes 918 represent an internal screwing mechanism for coupling first element 902 with second element 904. Each one of plurality of hinges 910 is inserted into a respective one of plurality of hinge spaces 924. Each one of plurality of cutters 912 is inserted into a respective one of plurality of cutter spaces 926. Each one of cutter spaces 926 is substantially aligned with a respective one of plurality of openings 920. Within each one of plurality of cutter spaces 926 is a spring pinhole (not shown in FIG. 9A). Half of plurality of springs 906 is coupled with first element 902 by inserting the respective coupling end 931 of a respective spring 906 into a respective spring pinhole (not shown) in a respective cutter space 926 of first element 902. The other half of plurality of springs 906 is coupled with second element 904 by inserting the respective coupling end 931 of a respective spring 906 into a respective spring pinhole (not shown) in a respective cutter space 926 of second element 904.

Each hinge 910 is inserted through a respective spring 906 and a respective cutter 912. As shown in more detail in FIGS. 9B, 9C, 9D and 9E, each of cutters 912 is shaped with two annular ends for inserting a respective one of plurality of hinges 910 there through. It is noted that each of cutters 912 can be shaped with at least one annular end (not shown) for inserting a respective one of plurality of hinges 910 there through. Each of one plurality of hinges 910 enables a respective one of plurality of cutters 912 to rotate radially away from hollow 922. When a given hinge 910 is inserted through a given cutter 912 and spring 906, and placed within a given cutter space 926, a proximal end 932 of force exerting end 933 of spring 906 exerts a spring force on flat surface 930 of cutter 912, thereby preventing cutter 912 from freely rotating around hinge 910. Plurality of openings 920 on first element 902 are located opposite plurality of openings 920 on second element 904, with the openings on first element 902 substantially being aligned with the openings on second element 904. Plurality of openings 920 enables plurality of cutters 912 to rotate radially beyond the exterior surface of first element 902 and second element 904, as shown below in FIG. 9C. Plurality of cutters 912 are arranged in pairs, as shown in FIG. 9A, and substantially aligned with respective ones of plurality of openings 920. It is noted that each of first element 902 and second element 904 is a single whole element, and is constructed from a particular substance, such as a single piece of metal, like steel.

Cross section VII in FIG. 9A shows a cross section of nibbling mechanism 900 perpendicular to hollow 922 of a cutter 912. Cross section VIII in FIG. 9A shows a cross section of nibbling mechanism 900 perpendicular to hollow 922 of a screw hole 918 and an alignment pinhole 908. Cross sections VII and VIII are shown in FIG. 9B. Cross section IX in FIG. 9A shows a cross section of nibbling mechanism 900 parallel to hollow 922 of a proximal end of nibbling mechanism 900 with a cutter moving mechanism. Cross section IX is shown in FIG. 9D.

Reference is now made to FIG. 9B which is a schematic illustration of cross sections VII and VIII of nibbling mechanism 900, shown in an assembled perspective view. Cross section VII shows how first element 902 and second element 904 couple together to form a nibbling mechanism. In cross section VII, two spring pinholes 934 are visible, into which a respective coupling end 931 of a respective spring 906 is inserted. As shown, opening 920 in first element 902 is aligned opposite to opening 920 in second element 904. Also shown clearer is how proximal end 932 of force exerting end 933 of spring 906 exerts a spring force on flat surface 930 of cutter 912, thereby preventing cutter 912 from freely rotating around hinge 910. In cross section VII is it shown that the end section of curved surface 916 proximal to hollow 922 is formed with teeth 936. Teeth are formed on curved surface 916 to enable buildup of debris and dirt in cutter 912 to escape, thereby enabling cutter 912 to retract to a closed position (i.e., within the exterior surface of first element 902 and second element 904), as shown in FIG. 9B. In cross section VIII, alignment pinhole 908 and an inserted alignment pin 928 are shown more clearly, as well as a screw hole 918. Screw hole 918 is larger at one end and smaller at the other end to accommodate the head of a fastening element, such as a screw or bolt at the larger end. As shown, the larger end of screw hole 918 may be placed in respective opposite positions on first element 902 and second element 904. Plurality of screw holes 918 enables first element 902 to be strongly coupled with second element 904.

Reference is now made to FIG. 9C, which is a schematic illustration of cross section VII of nibbling mechanism 900, in a nibbling mode. As described in greater detail below in FIGS. 9D and 9E, in a nibbling mode, a cutter moving mechanism 938 is inserted into hollow 922. Cutter moving mechanism 938 substantially forces each cutting surface 914 of each cutter 912 to rotate and protrude from the exterior surface of nibbling mechanism 900, as depicted by circumference 940 of first element 902 and second element 904. It is noted that cutter moving mechanism 938 does not rotate in a counter clockwise direction to force each cutting surface 914 of each cutter 912 to protrude from the exterior surface of nibbling mechanism 900. Rather, as cutter moving mechanism 938 is pushed into hollow 922, a tapered end section (not shown in FIG. 9C, shown in FIGS. 9D and 9E) of cutter moving mechanism 938 gradually forces each cutting surface 914 of each cutter 912 to protrude from the exterior surface of nibbling mechanism 900. Cutter moving mechanism 938 does not rotate relative to opening 920. As cutter moving mechanism 938 rotates, it forces first element 902 and second element 904 to rotate as well. Cutter moving mechanism 938 rotates cutting surface 914 in a clockwise direction thereby enabling a depression (not shown) to be formed within a construction material (not shown) into which nibbling mechanism 900 is inserted into. Cutter moving mechanism 938 can also rotate in a counter clockwise direction. As shown in FIG. 9C, hollow 922, as well as cutter moving mechanism 938 have an elliptical-like shape, having a major axis 941 and a minor axis 939, with major axis 941 being substantially longer than minor axis 939.

Reference is now made to FIGS. 9D and 9E. FIG. 9D is a schematic illustration of cross section IX of nibbling mechanism 900, including cutter moving mechanism 938. FIG. 9E is a schematic illustration of the cross section of FIG. 9D in a perspective view. Cutter moving mechanism is formed as a shaft, with the distal end of the shaft being shown in FIGS. 9D and 9E. Section 942 of cutter moving mechanism 938 substantially represents the shape of cutter moving mechanism 938 from its proximal end (not shown) to the distal end shown in FIG. 9D, and is substantially straight. The distal end of cutter moving mechanism 938 includes a tapered section 944, an additional straight section 946, a tapered end section 948 and a cap section 950. Section 942 and additional straight section 946 are substantially the same size and shape of hollow 922. Tapered section 944 includes flat surfaces 945 and grooves 947, better shown in FIG. 9E. First element 902 and second element 904 (not shown in FIGS. 9D and 9E) also include a hollow 956, which includes a slit, located at a proximal end of first element 902 and second element 904. Two binding pins 952 are inserted into hollow 956. Each one of binding pins 952 includes a spring receptacle 954. A half ring (not shown) is inserted into the slit of hollow 956, having springs (not shown) at each end which are each inserted into spring receptacles 954. In this manner, binding pins 952 remain inside nibbling mechanism 900, exerting an inward force towards hollow 922. Binding pins 952 can slide into grooves 947. In a nibbling mode, cap section 950 in inserted into hollow 922 and is moved forward until it comes in contact with the first cutter in nibbling mechanism 900. Cutter moving mechanism 938 is then pushed further into nibbling mechanism 900. Tapered end section 948 exerts a radial force on cutter 912, rotating and protruding cutter 912 out of opening 920 and into a construction material (not shown) to form a depression (not shown). Cutter moving mechanism 938 does not rotate in order to rotate cutter 912 such that it protrudes out of opening 920. Once cutter 912 has been fully rotated out of opening 920, cutter moving mechanism 938 is pushed further into nibbling mechanism 900 until the next cutter, and so forth. When each of plurality of cutters 912 has formed a respective depression in the construction material, cutter moving mechanism 938 is retracted. Due to the shape of additional straight section 946 and the location of binding pins 952, as cutter moving mechanism 938 is retracted, a proximal end 951 of additional straight section 946 exerts a force on binding pins 952, which in turn exerts a force on nibbling mechanism 900. As cutter moving mechanism 938 is retracted, when proximal end 951 of additional straight section 946 comes in contact with binding pins 952, nibbling mechanism 900 is retracted as well.

Reference is now made to FIGS. 9F_{/1} and 9F_{/2}, which are schematic illustrations of nibbling mechanism 900, including cutter moving mechanism 938, shown in various perspective and orthogonal views labeled A, B, C, D, E and F. As shown, cutter moving mechanism 938 is coupled with a chuck 958 of a power drill (not shown) for rotating cutter moving mechanism 938. As shown in view A, proximal end 962 and distal end 960 of nibbling mechanism 900 do not include plurality of openings 902 or plurality of cutters 912. Distal end 960 does not include plurality of cutters 912 since cap section 950 of cutter moving mechanism 938 is tapered, and at distal end 960 of nibbling mechanism 900, it cannot exert a radial force on a cutter were a cutter placed there. Proximal end 962 does not include plurality of cutters 912 since proximal end 962 is located at the beginning of a hole (not shown) drilled into a construction material. At such a location, other construction materials, such as metal or iron beams, may be present in the construction material, and forming depressions in such locations may weaken the construction material.

Following is a description of a method for preparing a cavity (not shown) with a plurality of depressions within a construction material (not shown) using nibbling mechanism 900. The user drills a hole (not shown) in a construction material, with the aid of a power drill (not shown), as known in the art. The hole which is drilled is slightly larger in diameter than the diameter of nibbling mechanism 900. For example, the difference in diameter between the hole drilled and nibbling mechanism 900 may be 2 millimeters (i.e., a difference of 1 millimeter in radius). It is noted that by drilling a hole slightly larger in diameter than the diameter of nibbling mechanism 900, when plurality of cutters 912 carve out respective depressions in the construction material, the accumulated dust and debris from the construction material have a space in which to escape. In this respect, nibbling mechanism 900 does not require a helical groove, usually in the form of flutes as shown above (for example in FIGS. 1A, 2B and 3A), to remove dust produced from the nibbling action of nibbling mechanism 900, out of the hole in which nibbling mechanism 900 was inserted into. In addition, as mentioned above, compressed air can be used while using nibbling mechanism 900 to force accumulated dust and debris out of the hole in which nibbling mechanism 900 was inserted into. Compressed air can be introduced into nibbling mechanism 900 while nibbling mechanism 900 is in use by providing the compressed air to the space between cutter moving mechanism 938 and opening 920 (as shown in FIG. 9C). In addition, as mentioned above, cutter moving mechanism 938 can be produced as a hollow cutter moving mechanism (not shown) and may include lengthwise holes along the wall of the threaded portion. With reference to FIGS. 9F_{/1} and 9F_{/2}, the user inserts proximal end of cutter moving mechanism 938 in chuck 958 of a power drill (not shown), and inserts nibbling mechanism 900 into the hole. Cutter moving mechanism 938 is then inserted into nibbling mechanism 900. When the power drill rotates cutter moving mechanism 938, nibbling mechanism 900 is rotated as well, due to the shape of hollow 922 and cutter moving mechanism 938. As cutter moving mechanism 938 is pushed into nibbling mechanism 900, each of cutting surfaces 914 protrudes from openings 920, and carves a respective depression (not shown) within the construction material. As cutter moving mechanism 938 is removed from nibbling mechanism 900, the spring force of springs 906 retracts plurality of cutters 912 back into plurality of openings 920, thereby allowing the user to withdraw nibbling mechanism 900 from the cavity. As mentioned above, teeth (not shown) on plurality of cutters 912, enable dust accumulated from the nibbling mechanism to escape, thereby enabling each one of plurality of cutters 912 to fully retract back into plurality of openings 920. Binding pins 952 and the proximal end of the additional straight section (not shown) of cutter mechanism 938 enable cutter moving mechanism 938 to pull nibbling mechanism 900 from the cavity.

It will be appreciated by persons skilled in the art that the disclosed technique is not limited to what has been particularly shown and described hereinabove. Rather the scope of the disclosed technique is defined only by the claims, which follow.

1. Nibbling mechanism for producing a plurality of indented surfaces within a cavity within a construction material, comprising:
a rod, rotatable by a power shaft rotator, said rod comprising a rod longitudinal axis;
a plurality of cutters, each of said cutters coupled with said rod, for producing said plurality of indented surfaces within said cavity; and
a cutter moving mechanism, coupled with said plurality of cutters, for forcing said plurality of cutters in a radial direction away from said rod longitudinal axis toward said cavity, thereby producing said plurality of indented surfaces.

2. The nibbling mechanism according to claim 1, said rod comprising a plurality of grooves on an outer surface of said rod, each one of said plurality of grooves for enabling a respective one of said plurality of cutters to slide in said radial direction away from said rod longitudinal axis, each one of said plurality of grooves comprising:
a substantially straight portion lying substantially parallel with said rod longitudinal axis; and
a curved portion, coupled with said substantially straight portion, pointing from said substantially straight portion toward said rod longitudinal axis,
wherein an outer diameter of said rod is smaller than or equal to an inner diameter of said cutter moving mechanism such that said rod can be inserted into said cutter moving mechanism,
each one of said plurality of cutters comprising:
a cutting edge, for producing a respective one of said plurality of indented surfaces;
a guide, for guiding the movement of a respective one of said plurality of cutters along a respective one of said plurality of grooves; and
a support surface, located between said cutting edge and said guide, for supporting said respective one of said plurality of cutters while said cutting edge produces said respective one of said plurality of indented surfaces,
wherein said support surface is located between said outer surface of said rod and an inner surface of said cutter moving mechanism.

3. The nibbling mechanism according to claim 1, said cutter moving mechanism comprising:
a tube; and
a spring,
said tube comprising:
an opening, for inserting said rod into said tube;
a plurality of slots, for enabling said plurality of cutters to protrude from said tube into said cavity;
a helical groove, for carrying a portion of said construction material, produced as a result of producing said plurality of indented surfaces, toward said opening; and
a cap,
wherein said spring is located between said cap and said rod when said rod is inserted into said tube, said spring forcing said rod in a direction away from said cap,
wherein an outer diameter of said cutter moving mechanism is smaller than or equal to an inner diameter of said cavity, and
wherein a length of said cutter moving mechanism is shorter than or equal to a length of said cavity, such that said cutter moving mechanism can be fully inserted into said cavity.

4-7. (canceled)

8. The nibbling mechanism according to claim 3, wherein said tube is hollow, said tube further comprising a plurality of lengthwise holes.

9. The nibbling mechanism according to claim 1, wherein compressed air is provided to said nibbling mechanism, between said rod and said cutter moving mechanism, for forcing a portion of said construction material, produced as a result of producing said plurality of indented surfaces, out of said cavity.

10-14. (canceled)

15. The nibbling mechanism according to claim 1, wherein an anchor is inserted into said cavity after said plurality of indented surfaces have been produced in said cavity, said anchor being coupled with said cavity with a settable material.

16-17. (canceled)

18. The nibbling mechanism according to claim 2, wherein a cross-section shape of said cutting edge is selected from the list consisting of:
sawtooth shape;
triangular shape;
rectangular shape;
round shape.

19. Nibbling mechanism for producing a plurality of indented surfaces within a cavity within a construction material, comprising:
a tube, rotatable by a power shaft rotator, said tube comprising a tube longitudinal axis;
a plurality of cutters, each of said cutters coupled with said tube, for producing said plurality of indented surfaces within said cavity; and
a cutter moving mechanism, coupled with said plurality of cutters, for forcing said plurality of cutters in a radial direction away from said tube longitudinal axis toward said cavity, thereby producing said plurality of indented surfaces,
wherein said cutter moving mechanism can be inserted into said tube.

20-23. (canceled)

24. The nibbling mechanism according to claim 8, wherein an anchor is inserted into said cavity after said plurality of indented surfaces have been produced in said cavity, said anchor being coupled with said cavity with a settable material.

25. (canceled)

26. The nibbling mechanism according to claim 8, wherein compressed air is provided to said nibbling mechanism, for forcing a portion of said construction material, produced as a result of producing said plurality of indented surfaces, out of said cavity.

27. The nibbling mechanism according to claim 8, wherein said tube is comprised of two longitudinal halves coupled to one another.

28. (canceled)

29. The nibbling mechanism according to claim 8, said tube comprising:
a tube opening, for inserting said cutter moving mechanism into said tube;
a plurality of openings, for enabling said plurality of cutters to protrude from said tube into said cavity;
a helical groove, for carrying a portion of said construction material, produced as a result of producing said plurality of indented surfaces, toward said tube opening;
a plurality of tube pinholes, located in the vicinity of and on two sides of respective ones of said plurality of openings;
a front bearing, located at a front end of said tube, within said tube;
a rear bearing, located at a rear end of said tube, within said tube; and
a cap, said cutter moving mechanism comprising:
a piston, located within said tube, substantially parallel to said tube longitudinal axis;
a retaining ring; and
a spring, located between said retaining ring and said cap, said spring forcing said tube to move relative to said piston,
said piston comprising:
a retaining ring groove, located at a front end of said piston, for coupling said retaining ring;
a front journal, located at said front end of said piston, said front journal being located within said front bearing;
a rear journal, located at a rear end of said piston, said rear journal being located within said rear bearing;
a plurality of piston indented surfaces; and
a plurality of piston pinholes, located within said piston, in the vicinity of and on two sides of respective ones of said plurality of piston indented surfaces.

30-32. (canceled)

33. The nibbling mechanism according to claim 12, each one of said plurality of cutters being coupled with said tube by a plurality of respective tube pins, each one of said plurality of respective tube pins being located within a respective one of said plurality of tube pinholes, and each one of said plurality of cutters being further coupled with said piston by a plurality of respective piston pins, each one of said respective piston pins being located within a respective one of said plurality of piston pinholes, wherein each one of said plurality of cutters rotates about said respective tube pin and said respective piston pin as said tube moves relative to said piston when said tube is pushed against said spring, thereby forcing each one of said plurality of cutters in said radial direction away from said tube longitudinal axis toward said cavity, thereby producing said plurality of indented surfaces.

34. Nibbling mechanism for producing a plurality of indented surfaces within a cavity within a construction material, comprising:
a tube, rotatable by a power shaft rotator, said tube comprising a tube longitudinal axis;
a plurality of cutters, each of said cutters coupled with said tube, for producing said plurality of indented surfaces within said cavity; and
a cutter moving mechanism, for forcing said plurality of cutters in a radial direction away from said tube longitudinal axis toward said cavity, thereby producing said plurality of indented surfaces, wherein said cutter moving mechanism can be inserted into said tube.

35. The nibbling mechanism according to claim 14, wherein said construction material is selected from the list consisting of:
concrete;
masonry;
rock;
pile;
stone;
marble; and
granite.

36-38. (canceled)

39. The nibbling mechanism according to claim 14, wherein an anchor is inserted into said cavity after said plurality of indented surfaces have been produced in said cavity, said anchor being coupled with said cavity with a settable material.

40. The nibbling mechanism according to claim 16, wherein said settable material is selected from the list consisting of:
a resin;
an epoxy;
an unsaturated polyester made of diols and dicarbolic acids;
a styrene free vinylester;
a hybrid system;
an adhesive;
grout;
epoxy grout;
cement-based grout; and
furan resin grout.

41. The nibbling mechanism according to claim 14, wherein compressed air is provided to said nibbling mechanism, for forcing a portion of said construction material, produced as a result of producing said plurality of indented surfaces, out of said cavity.

42-43. (canceled)

44. The nibbling mechanism according to claim 14, wherein said tube is hollow, said tube further comprising a plurality of lengthwise holes.

45. The nibbling mechanism according to claim 14, said tube comprising:
a tube opening, for inserting said cutter moving mechanism into said tube;
a helical groove, for carrying a portion of said construction material, produced as a result of producing said plurality of indented surfaces, toward said tube opening; and
a plurality of openings located within said tube.

46. (canceled)

47. The nibbling mechanism according to claim 20, said cutter moving mechanism being in the form of a rod, said rod lying substantially along said tube longitudinal axis, said cutter moving mechanism rotating within said tube about said tube longitudinal axis, said cutter moving mechanism comprising:
a plurality of eccentric surfaces, each one of said eccentric surfaces being defined by a first radius smaller than the radius of said rod, and by a second radius larger than said first radius and smaller than the radius of said rod, each one of said eccentric surfaces defining a first intersection on said rod at said first radius, each one of said eccentric surfaces also defining a second intersection on said rod at said second radius;
a first set of stop surfaces being defined by respective ones of said first intersections and the outer surface of said rod; and
a second set of stop surfaces being defined by respective ones of said second intersections and the outer surface of said rod,
each one of said cutters comprising:
a spring portion, in the form of a leaf spring, said spring portion being coupled with said tube;
a solid portion, coupled with said spring portion, said solid portion being located within a respective one of said plurality of openings, said spring portion forcing said solid portion toward a respective one of said plurality of eccentric surfaces; and
a cutting portion, coupled with said solid portion and adjacent to said spring portion,
wherein when said solid portion is located at a respective one of said first intersections, said cutting portion is flush with the outer surface of said tube, and when said solid portion is located at a respective one of said second intersections, said cutting portion protrudes from a respective one of said plurality of openings, thereby producing said plurality of indented surfaces, and
wherein said solid portion moves from said first intersection to said second intersection as said rod rotates about said tube longitudinal axis.

48. The nibbling mechanism according to claim 20, said tube further comprising:
a front bearing, located at a front end of said tube, within said tube; and
a rear bearing, located at a rear end of said tube, within said tube, and
said cutter moving mechanism further comprising:
a front journal, located at a front end of said cutter moving mechanism, said front journal being further located within said front bearing of said tube,
a rear journal, located at a rear end of said cutter moving mechanism, said rear journal being further located within said rear bearing of said tube.

49-50. (canceled)

51. The nibbling mechanism according to claim 14, said tube comprising:
a tube opening, for inserting said cutter moving mechanism into said tube;
a plurality of openings, for enabling said plurality of cutters to protrude from said tube into said cavity;
a helical groove, for carrying a portion of said construction material, produced as a result of producing said plurality of indented surfaces, toward said tube opening;
a front bearing, located at a front end of said tube; and
a rear bearing, located at a rear end of said tube.

52. (canceled)

53. The nibbling mechanism according to claim 23, said cutter moving mechanism being in the form of a rod, said rod lying substantially along said tube longitudinal axis, said cutter moving mechanism rotating within said tube about said tube longitudinal axis, said cutter moving mechanism comprising:
a front journal, located at a front end of said rod, said front journal being located within said front bearing;
a rear journal, located at a rear end of said rod, said rear journal being located within said rear bearing;
a curved portion, located between said front journal and said rear journal, said curved portion substantially lying along said tube longitudinal axis;
a cylindrical portion, coupled with said curved portion after said rear journal, said cylindrical portion to be coupled with said power shaft rotator; and
a plurality of springs,
wherein said curved portion is defined by a cross-section having a first axis and a second axis, said second axis being longer than said first axis, said first axis defining a low elevation portion of said curved portion and said second axis defining a high elevation portion of said curved portion.

54. The nibbling mechanism of claim 24, said plurality of cutters comprising:
a plurality of cutting edges;
a plurality of cutter outer surfaces; and
a cutter inner surface, coupled with said curved portion.

55. The nibbling mechanism of claim 25, wherein each one of said plurality of springs is located between respective ones of said plurality of cutting edges, between said tube and said plurality of cutter outer surfaces, each one of said plurality of springs applying a spring force on a respective one of said plurality of cutter outer surfaces, said spring force forcing said plurality of cutters toward said tube longitudinal axis,
wherein said cutter inner surface makes contact with said low elevation portion,
wherein said cutter inner surface slides on said curved portion, from said low elevation portion toward said high elevation portion, when said cylindrical portion is rotated by said power shaft rotator, thereby enabling each one of said plurality of cutting edges to protrude from respective ones of said plurality of openings and producing said plurality of indented surfaces.

56. The nibbling mechanism according to claim 24, wherein said cross-section is in the form of an ellipse.

57. (canceled)

58. The nibbling mechanism according to claim 14, said tube comprising:
a tube opening, for inserting said cutter moving mechanism into said tube;
a plurality of openings, for enabling said plurality of cutters to protrude from said tube into said cavity;
a helical groove, for carrying a portion of said construction material, produced as a result of producing said plurality of indented surfaces, toward said tube opening;
a plurality of bearings, located within said tube at a rear end of said tube, each one of said plurality of bearings being in the form of an arc of a circle; and
a conical portion, located at a front end of said tube.

59. (canceled)

60. The nibbling mechanism according to claim 28, said conical portion comprising:
a conical base, located at said front end of said tube;
a conical apex, located between said conical base and said rear end of said tube;
a conical surface, defined by said conical base and said conical apex; and
an internal thread, located within said conical portion at said conical apex,
said cutter moving mechanism being in the form of a rod, said rod lying substantially along said tube longitudinal axis, said cutter moving mechanism rotating within said tube about said tube longitudinal axis and also moving linearly along said tube longitudinal axis, said cutter moving mechanism comprising:
a cylindrical portion, located at a rear end of said cutter moving mechanism, said cylindrical portion to be coupled with said power shaft rotator;
a plurality of springs; and
a cutter moving conical portion, located at said rear end of said cutter moving mechanism, said moving mechanism conical portion comprising:
a moving mechanism conical base at said rear end of said cutter moving mechanism;
a moving mechanism conical apex, located between said moving mechanism conical base and a front end of said cutter moving mechanism;
a moving mechanism conical surface defined by said moving mechanism conical base and said moving mechanism conical apex;
a plurality of spikes, located at said moving mechanism conical base, each one of said plurality of spikes being further located within respective ones of said plurality of bearings; and
a threaded portion, located at said moving mechanism conical apex, said threaded portion having an external thread at a front end of said threaded portion,
wherein screw thread parameters of said external thread are substantially similar to screw thread parameters of said internal thread,
said plurality of cutters comprising:
a plurality of cutting edges;
a plurality of cutter outer surfaces;
a cutter inner surface;
a front guiding surface; and
a rear guiding surface,
wherein said plurality of springs are located between respective ones of said plurality of cutting edges, and between said plurality of cutter outer surfaces and said tube.

61-62. (canceled)

63. The nibbling mechanism according to claim 29, wherein each of said plurality of springs applies a spring force on respective ones of said plurality of cutter outer surfaces, thereby causing said front guiding surface of said plurality of cutters to make contact with said conical surface and causing said rear guiding surface of said plurality of cutters to make contact with said moving mechanism conical surface;
wherein the slope of said front guiding surface is substantially similar to the slope of said conical portion and the slope of said rear guiding surface is substantially similar to the slope of said moving mechanism conical portion;
wherein the distance between said conical apex and said moving mechanism conical apex decreases when said cylindrical portion of said cutter moving mechanism is rotated in a first direction, forcing said front guiding surface to slide on said conical surface and said rear guiding surface to slide on said moving mechanism conical surface, thereby causing said cutter moving mechanism to move linearly along said tube longitudinal axis, and enabling said plurality of cutting edges to protrude from respective ones of said plurality of openings, thereby producing said plurality of indented surfaces; and
wherein the distance between said conical apex and said moving mechanism conical apex increases when said cylindrical portion of said cutter moving mechanism is rotated in a second direction, forcing said front guiding surface to slide on said conical surface and said rear guiding surface to slide on said moving mechanism conical surface, thereby causing said cutter moving mechanism to move linearly along said tube longitudinal axis, and enabling said plurality of cutting edges to retract such that said plurality of cutting edges align with said tube.

64. (canceled)

65. The nibbling mechanism according to claim 14, said tube comprising:
a tube opening, for inserting said cutter moving mechanism into said tube;
a helical groove, for carrying a portion of said construction material, produced as a result of producing said plurality of indented surfaces, toward said tube opening;
a plurality of openings, for enabling said plurality of cutters to protrude from said tube into said cavity; and
a plurality of tube indented surfaces, located within said tube.

66. (canceled)

67. The nibbling mechanism according to claim 31, said cutter moving mechanism comprising:
a plurality of springs, located within respective ones of said plurality of tube indented surfaces; and
a shaft, located within said tube, substantially lying along said tube longitudinal axis,
said shaft comprising:
a power shaft attachment portion, said power shaft attachment portion to be coupled with said power shaft rotator; and
a polygonal portion;
wherein said polygonal portion is in the form of a frustum of a pyramid, a base of said pyramid being located near said tube opening and an apex of said pyramid being located within said tube, said base and said apex defining a plurality of substantially flat surfaces; and
wherein a cross-section of said polygonal portion is in the form of a polygon, each one of said plurality of cutters comprising:
a cutting edge, substantially aligned with a respective one of said plurality of cutters;
a flat portion; and
a plurality of cutter outer surfaces.

68. (canceled)

69. The nibbling mechanism according to claim 32, wherein each one of said plurality of springs is also located between respective ones of said plurality of cutter outer surfaces, each one of said plurality of springs applying a spring force on said plurality of cutter outer surfaces such that a respective one of said flat portion makes contact with a respective one of said plurality of substantially flat surfaces,
wherein said shaft moves linearly along said tube longitudinal axis, thereby causing each one of said respective substantially flat surfaces to slide relative to said respective one of said flat portion, and enabling a respective cutting edge of each one of said plurality of cutters to protrude from respective ones of said plurality of openings, thereby producing said plurality of indented surfaces.

70. The nibbling mechanism according to claim 32, wherein said polygon is selected from a list consisting of:
square;
rectangle;
triangle;
pentagon; and
hexagon.

71. The nibbling mechanism according to claim 32, said shaft further comprising a plurality of grooves on an outer surface of said shaft, and said plurality of cutters further comprising a plurality of protrusions protruding from said flat portion, each one of said plurality of protrusions being located within respective ones of said plurality of grooves.

72. The nibbling mechanism according to claim 31, said tube further comprising:
a tube symmetric plane, substantially intersecting said tube longitudinal axis;
a thread symmetric plane, substantially intersecting said tube longitudinal axis, said thread symmetric plane being substantially normal to said tube symmetric plane;
a first longitudinal half, located on a first side of said tube symmetric plane;
a second longitudinal half, substantially symmetrically located on a second side of said tube symmetric plane;
a plurality of spacers, located between said first longitudinal half and said second longitudinal half; and
a plurality of bolts, for coupling said first longitudinal half with said second longitudinal half.

73. The nibbling mechanism according to claim 36, said first longitudinal half comprising:
a first longitudinal half substantially flat surface substantially parallel with said tube symmetric plane;
a first longitudinal cavity, located in said first longitudinal half substantially flat surface, lying substantially along said tube longitudinal axis;
a first set of openings, said first set of openings lying substantially on said thread symmetric plane;
a first set of internal threads, located at a first thread side of said thread symmetric plane,
being substantially perpendicular to said tube symmetric plane; and
a second set of internal threads located at a second thread side of said thread symmetric plane, being substantially perpendicular to said tube symmetric plane,
said second longitudinal half comprising:
a second longitudinal half substantially flat surface substantially parallel with said tube symmetric plane;
a second longitudinal cavity, located in said second longitudinal half substantially flat surface, lying substantially along said tube longitudinal axis;
a second set of openings, said second set of openings lying substantially on said thread symmetric plane;
a first set of bolt openings, located at a first bolt side of said thread symmetric plane, being substantially perpendicular to said tube symmetric plane; and
a second set of bolt openings, located at a second bolt side of said thread symmetric plane, being substantially perpendicular to said tube symmetric plane,
wherein said plurality of bolts are screwed into each of said first set of internal threads, said second set of internal threads, said first set of bolt openings and said second set of bolt openings.

74. (canceled)

75. The nibbling mechanism according to claim 14, said tube comprising:
a plurality of springs;
a plurality of hinges, coupled with said plurality of springs and with said plurality of cutters, for enabling said plurality of cutters to rotate in said radial direction;
a first element; and
a second element,
each of said first element and said second element comprising:
a plurality of screw holes;
a plurality of openings, for enabling said plurality of cutters to protrude from said tube into said cavity;
a hollow, for inserting said cutter moving mechanism into said tube;
a plurality of hinge spaces, for housing said plurality of hinges;
a plurality of cutter spaces, for housing said plurality of cutters, respective ones of said plurality of cutter spaces being aligned with respective ones of said plurality of openings; and
a plurality of spring pinholes, respectively located within said plurality of cutter spaces, for coupling half of said plurality of springs with said first element and for coupling the other half of said plurality of springs with said second element,
wherein said plurality of openings on said first element are aligned with respective ones of said plurality of openings on said second element.

76. The nibbling mechanism according to claim 38, wherein said first element is coupled with said second element using a fastening element placed in said plurality of screw holes.

77-78. (canceled)

79. The nibbling mechanism according to claim 38, each one of said plurality of cutters comprising:
a cutting surface;
a curved surface;
a flat surface; and
at least one annular end,
wherein each one of said plurality of hinges is inserted through a respective one of said at least one annular end and through a respective one of said plurality of springs.

80. The nibbling mechanism according to claim 40, each one of said plurality of springs comprising a coupling end and a force exerting end, wherein a respective one of said coupling end is inserted into a respective one of said plurality of spring pinholes and wherein a respective one of said force exerting end exerts a spring force on a respective one of said flat surface, thereby preventing said plurality of cutters from freely rotating about said plurality of hinges, and wherein said curved surface comprises a plurality of teeth, for enabling a portion of said construction material, produced as a result of producing said plurality of indented surfaces, to escape.

81. (canceled)

82. The nibbling mechanism according to claim 38, wherein said cutter moving mechanism is defined by a cross-section with an elliptical-like shape, said elliptical-like shape comprising a major axis and a minor axis,
wherein a cross-section of said hollow is shaped substantially similar to said elliptical-like shape.

83. The nibbling mechanism according to claim 38, wherein a distal end of said cutter moving mechanism comprises:
a tapered section, said tapered section include a plurality of flat surfaces and a plurality of grooves;
a straight section, coupled with said tapered section, said straight section having a shape substantially similar to the shape of said hollow;
a tapered end section, coupled with said straight section; and
a cap, coupled with said tapered end section.

84. The nibbling mechanism according to claim 43, each of said first element and said second element further comprising a pin hollow, each said pin hollow located at a proximal end of each of said first element and said second element, each said pin hollow comprising a respective slit,
wherein said tube further comprises:
a set of binding pins, each one of said set of binding pins being located within a respective one of each said pin hollow, each one of said set of binding pins comprising a spring receptacle;
a set of binding pin springs, each one of said set of binding pin springs being located within a respective one of said spring receptacle; and
a half ring, said half ring being inserted into said slit and being coupled with said set of binding pins and said set of binding pin springs,
wherein said set of binding pins can slide into said plurality of grooves, thereby exerting an inward force towards said hollow on said cutter moving mechanism; wherein said cap section is first inserted into said hollow;
wherein said tapered end section exerts a radial force sequentially on each respective one of said plurality of cutters, forcing said plurality of cutters in said radial direction away from said tube longitudinal axis toward said cavity, thereby producing said plurality of indented surfaces; and
wherein when said cutter moving mechanism is retracted from said cavity, a proximal end of said straight section exerts a pulling force on said set of binding pins, thereby retracting said tube from said cavity.

85. (canceled)

86. The nibbling mechanism according to claim 38, wherein said plurality of openings are located at a distance from a proximal end and a distal end of each one of said first element and said second element.

87-88. (canceled)

89. Method for producing a plurality of indented surfaces in a cavity in a construction material, for anchoring an anchor in said cavity, the method comprising the procedures of:
inserting a nibbling mechanism in said cavity in said construction material, said cavity and said nibbling mechanism each having a cylindrical body, said nibbling mechanism comprising a plurality of cutters;
producing a plurality of indented surfaces within said cavity, by forcing said plurality of cutters in a radial direction away from a longitudinal axis of said nibbling mechanism, while rotating said nibbling mechanism;
retracting said plurality of cutters away from said indented surfaces, back toward said longitudinal axis; and
removing said nibbling mechanism from said cavity.

90. The method according to claim 46, further comprising a preliminary procedure of drilling said cavity.

91. The method according to claim 46, further comprising the procedures of:
inserting said anchor in said cavity, after said plurality of indented surfaces have been produced in said cavity; and
coupling said anchor with said cavity with a settable material.

92. The method according to claim 46, wherein each one of said produced plurality of indented surfaces is annular.

93. The method according to claim 48, wherein said settable material is selected from the list consisting of:
a resin;
an epoxy;
an unsaturated polyester made of diols and dicarbolic acids;
a styrene free vinylester;
a hybrid system;
an adhesive;
grout;
epoxy grout;
cement-based grout; and
furan resin grout.

94. (canceled)
